(19) United States
(12) Patent Application Publication
(10) Pub. No.: US 2026/0052185 A1
(43) Pub. Date: Feb. 19, 2026

(54) PROFILING USER BEHAVIOR WITH PERSONAS, GROUNDED BY CONTEXT AND BASED ON SURVEY AND OTHER DATA

(71) Applicant: Claritas, LLC, Cincinnati, OH (US)

(72) Inventor: Jason Rex Briggs, Galena Forrest, NV (US)

(21) Appl. No.: 19/298,081

(22) Filed: Aug. 12, 2025

Related U.S. Application Data
(60) Provisional application No. 63/682,555, filed on Aug. 13, 2024.

(51) Int. Cl. H04L 67/306; G06F 9/451; G06Q 30/0242

(52) U.S. Cl. CPC H04L 67/306; G06F 9/451; G06Q 30/0244

(57) ABSTRACT

A method and system for profiling user behavior using personas, ground by context and based on survey and other data. Data associated with a segment is identified. The data comprises one or more characteristics of the segment. An interactive digital persona representing the segment is generated based on the data. The interactive digital persona representing the segment is caused to be provided to a user device.

### RELATED APPLICATIONS

This application claims the benefit under 35 U.S.C. § 119(c) of U.S. Provisional Patent Application No. 63/682,555, titled “Profiling User Behavior with Personas, Grounded by Context and based on Survey and Other Data,” filed on Aug. 13, 2024, the entire content of which his incorporated herein by reference.

### TECHNICAL FIELD

This disclosure relates to the field of artificial intelligence, and in particular to profiling user behavior with personas, grounded by context and based on survey and other data.

### BACKGROUND

Personas can be fictional representations of ideal consumers. Traditionally, a persona is a part played by an actor based on information about a target market. Personas can help in the understanding of the target market, and can facilitate the campaign strategies that resonate with the needs, wants, and behaviors of the target market.

### BRIEF DESCRIPTION OF THE DRAWINGS

The present disclosure will be understood more fully from the detailed description given below and from the accompanying drawings of various embodiments of the present disclosure, which, however, should not be taken to limit the present disclosure to the specific embodiments, but are for explanation and understanding only.

FIG. 1 illustrates an example of a system architecture for implementations of the present disclosure.

FIG. 2 depicts a flow diagram of a method for generating an interactive persona representing a segment of a population, in accordance with one or more aspects of the present disclosure.

FIG. 3 depicts a flow diagram of a method for training and using an AI model to represent a persona representing a segment of a population, in accordance with one or more aspects of the present disclosure.

FIG. 4 depicts a flow diagram of a method for identifying and providing additional data to a trained AI model representing a segment persona, in accordance with one or more aspects of the present disclosure.

FIG. 5A-B depicts a flow diagram of a method for identifying and providing additional data to a trained AI model to enhance the segment persona, in accordance with one or more aspects of the present disclosure.

FIG. 6 illustrates an example input data table, in accordance with one or more aspects of the present disclosure.

FIG. 7 illustrates an example user interface (UI) displaying a conversation with a persona provided by the trained AI model, in accordance with one or more aspects of the present disclosure.

FIG. 8 illustrates example UI components illustrating the interactive conversational capabilities of a persons provided by the trained AI model, in accordance with one or more aspects of the present disclosure.

FIG. 9 illustrates an example UI displaying an output of a trained AI model based on experience and/or context of a segment, in accordance with one or more aspects of the present disclosure.

FIGS. 10A-B illustrate example UIs displaying outputs of multiple trained AI models, each one representing a distinct segment, in accordance with one or more aspects of the present disclosure.

FIG. 11 illustrates an example UI displaying a comparative analysis of multiple trained AI models, each one representing a distinct segment and providing a distinct persona, in accordance with one or more aspects of the present disclosure.

FIG. 12 illustrates an example input data table of conversion rates for various segments, in accordance with one or more aspects of the present disclosure.

FIG. 13 illustrates an example of an avatar representing a segment of a population, in accordance with one or more aspects of the present disclosure.

FIG. 14 depicts a block diagram of an example computing system operating in accordance with one or more aspects of the present disclosure.

### DETAILED DESCRIPTION

Embodiments are described for profiling user behavior with personas provided by trained artificial intelligence (AI) models, grounded by context and based on survey and other data. A persona can refer to a representation of a consumer or a group of consumers that share similar backgrounds and/or characteristics. A persona can be a semi-fictional representation of a target customer that is created based on existing customer data. An organization can create a profile for a persona to help them tailor their marketing efforts to address specific needs and preferences of their customers. Organizations create a profile for a persona using existing customer data, and use the persona to tailor their marketing efforts. Traditional approaches to consumer profiling and persona development are limited by static, oversimplified representations that fail to capture the complexity and nuance of real-world consumer behaviors, attitudes, and motivations. Historically, personas have been created using aggregated demographic and psychographic data, often resulting in one-dimensional profiles that do not reflect the diversity or dynamic nature of actual consumer segments. These static personas are inflexible, lack personalization, and are unable to adapt to new contextual information or specific behavior triggers. Furthermore, attempts to make persons interactive, such as hiring actors to embody them, are costly, time-consuming, and prone to inaccuracies, as actors may deviate from the underlying data.

Additionally, the traditional one-dimensional personas created using aggregated demographic and psychographic data cannot be used to infer or explain the interplay of multiple characteristics within a population segment, or to understand how specific contextual factors influence consumer decisions. It can be difficult to identify patterns, make accurate predictions about segment behavior, and generate actionable insights using traditional one-dimensional personas, especially when trying to compare or contrast different segments' likelihood to take specific actions. Additionally, creating the traditional one-dimensional personas relied on a combination of data analysis, static modeling, and resource-intensive simulation, all of which led to significant inefficiencies in the use of computing resources. As new consumer data became available, new personas would be created, leading to an excessive use of memory, storage, and processing power.

Aspects of the present disclosure provide an artificial intelligence (AI) generated interactive digital persona of a consumer (or group of consumers, referred to as a segment) that is grounded in survey data, behavioral data, and/or contextual information. The interactive digital persona represents a population segment and is supported by a specific instance of an AI model that has been conditioned (e.g., fine-tuned, or improved using retrieval-augmented generation (RAG)) on segment-specific data. Aspects of the present disclosure enable a user to interact with the underlying data through the AI-generated interactive digital personas. The user's interactions with the persona can be realistic and conversational. The persona's responses can be generated by an instance of the AI model that has been conditioned on segment-specific characteristics, behaviors and/or experiences, and can be compared side-by-side with other personas to reveal nuanced differences between segments. Thus, the persona's responses remain consistent with the underlying data. In some embodiments, a trained AI model can generate a generic persona representing the segment using a segment profile. In some embodiments, a trained AI model can generate a more specific persona representing the segment based on additional experience and/or context data.

In some embodiments, the AI-driven persona can be based on a particular segment profile. A segment profile can include data points of collected survey data, as well as segment performance data for a particular campaign. A campaign can define a set of content items that have a coordinated message and call to action that achieve a specific objective within a particular timeframe, for example. The set of content items of a campaign can include multiple forms of media and communication channels to reach a targeted audience, to increase awareness for a particular subject matter, to generate interest and/or to drive specific actions (e.g., sign-ups for a particular program). A content item can correspond to any form of information provided via a network (e.g., provided via a web page, in an email message, in a text message, in a social media posting, etc.).

In some embodiments, a summary component can fine-tune a foundational AI model (e.g., a large language model (LLM)) using an initial profile of the segment. The initial profile of the segment can include a number of variables, such as, for example, an age range, employment status, home owner or home renter, social media engagement habits, car preference, online shopping habits, net worth, and/or notable engagements. As an illustrative example, values for the variables representing a particular segment can be: young adults between 18 and 24 years old, primarily students, primarily home renters, frequent social media engagement, prefer compact cars, sensitive to car prices, primarily online shoppers, low net worth (e.g., under $25,000), and engaged in eco-friendly activities. In some implementations, the initial profile can include data that indicates a contrast between the segment and other segments. The summary component can provide a trained AI model that supports an interactive digital persona based on the provided information in the initial segment profile. The AI-driven persona can enable a user to interact with the segment profile, e.g., by asking questions to the persona about the data.

In some embodiments, a persona component can provide additional data to further refine the fine-tuned trained AI model. The additional data can include, for example, index and incidence metrics specific to the segment. The incidence represents the percent of time a characteristic variable occurs within the segment of the population, and index represents the percent of time the characteristic variable occurs within the segment divided by the percent of time the characteristic variable occurs within the overall population. In other words, the incidence represents how common the characteristic is within the segment and the index represents how different the segment is from the overall population (and whether the characteristic variable is less or more likely to occur for the segment). The persona component can provide the additional data to the trained AI model to improve the performance of the trained AI model, e.g., using retrieval-augmented generation (RAG). RAG is a combination of techniques used in natural language processing and text generation. RAG can involve using data (e.g., the additional data described above and herein) to assist in generating new content. The RAG process can include the following steps: retrieval (finding relevant information from existing sources), augmentation (enhancing the found information with additional context or details), and generation (creating a coherent output based on the enhanced information). Thus, aspects of the present disclosure can provide a trained AI model that can retrieve relevant information using a foundational AI model, and can augment the retrieved information using additional data (e.g., index, incidence) to generate an interactive persona representing the segment.

The persona component can then enable a user device to access and/or interact with the trained AI model representing a segment persona improved by the additional data (e.g., index, incidence). The trained AI model enables a user to interact with the persona representing the segment profile by using the conversational capabilities of an LLM with the answers conditioned on the data provided via the persona overall description and the incidence and index data, for example. The user can interact with the persona to better understand the group of consumers represented by the segment, e.g., to drive a variety of strategy and tactical actions. For example, a user can interact with the persona by asking it direct questions about preferences and behaviors, such as “do you like baseball?” or “what type of car do you drive?” A user can use the persona's responses to brainstorm and/or refine campaign messaging, creative concepts, and/or product positioning. For example, a user can interact with a persona to identify what kind of foods the people who attend baseball games like. As an illustrative example, people who attend one baseball team's home games may prefer different foods than the people who attend another baseball team's home games. Thus, a user interacting with a particular persona may determine that the persona prefers gourmet burgers at baseball games, and thus may introduce upscale food options and/or tailor advertising to highlight these offerings at baseball games. As another example, a user can interact with the persona in an open-ended manner, such as asking the persona to tell a joke, describe a typical day, or suggest what kind of food they might enjoy at a baseball game. These interactions leverage the persona's backstory (e.g., initial profile) and inferred preferences, event for topics not explicitly present in the data, by drawing on the foundational model's general knowledge and the segment's defining traits. As another example, a user can interact with a persona during a new product development process, to help develop a new product tailored for a particular segment based on responses provided by the persona.

In some embodiments, a persona plus component can provide additional data to the trained AI model, such as context or experience data. Experience data can reflect an action that a member of the segment has taken with respect to a particular campaign. The action can be a conversion, for example. Context data can include additional data with respect to the conversion (e.g., an image of the content item that led to the conversion, a uniform resource locator (URL) of a webpage associated with the conversion, etc.). The persona plus component can provide the additional context and/or experience data to the trained AI model to further improve the performance of the trained AI model, e.g., using retrieval-augmented generation (RAG). The persona component can then enable a user device to access and/or interact with the trained AI model (e.g., via an interface to the trained AI model) representing a segment persona improved by the additional data, the context data, and/or the experience data. Thus, the answers of the trained AI model (e.g., the LLM) can be conditioned based on the specifics of the experience and context in which the persona is producing output.

As an example, a user can interact with a persona provided by the persona plus component using contextual and/or conditional queries. For example, after providing context that the persona has purchased a baseball ticket or visited a particular website, the user can interact with the persona by asking “what motivated you to buy a ticket to that baseball game?” or “what did you find appealing about the car you just purchased?” The persona's responses are informed by both its segment data and the specific context and/or experience data. As another example, a user can identify unmet needs or desirable features by questioning a persona about the persona's preferences, pain points, and/or motivations. For example, if a segment persona expresses a strong interest in eco-friendly vehicles, a user may prioritize eco-friendly features or develop targeted eco-friendly marketing for that segment.

In some embodiments, a multiple persona component can provide a user with access to multiple trained AI models, each trained AI model representing a specific segment of a population and thus corresponding to a different persona. The multiple persona component can provide the same prompt to each of the trained AI models (e.g., to each of the personas), and can provide the output of each trained AI model, e.g., in a side-by-side display, enabling a user to compare the segments. Accordingly, each AI model may generate or adopt a different persona, and each of the personas may be used to respond to an inquiry in a manner appropriate to the segment of the population represented by that persona. In an example, the multiple persona component can be used as a focus group for a particular product.

The multiple persona component can enable a user device to access and/or interact with multiple trained AI models, each representing a specific segment. The user can interact with the multiple personas to explore segment differences. An example interaction can be “which of you is most likely to buy this new vehicle?” or “what type of people do you think would not enjoy attending a professional basketball game?” Each persona can respond according to its segment's likelihood and characteristics, providing a side-by-side view of different consumer perspectives. By comparing responses across multiple personas, a user can identify which segments are most likely to convert for a given product or campaign, for example. These interactions can enable more precise audience targeting, such as focusing ad spend on high-index segments or developing specialized offers for underperforming groups. As another example, a user can interact with the persona(s) to optimize a campaign. For example, the personas' responses can reveal to a user why certain segments are not engaging with a campaign, allowing the user to adults creative, offers, and/or channels. For example, if a persona representing a low-conversion segment for a particular campaign indicates a preference for symphony tickets over basketball games, a user may experiment with different value propositions and/or cross-promotional opportunities.

In some embodiments, an aggregated personas component can combine the output of multiple trained AI models, each AI model representing a specific segment of a population (e.g., each AI model corresponding to a different persona). The aggregated personas component can provide an analysis of a range of personas at once. The aggregated personas component can provide an input to multiple trained AI models, each corresponding to a different persona, and can combine the outputs from each trained AI model to generate an aggregated output. In some embodiments, the aggregated personas component can compare the outputs of the multiple trained AI models, and provide an analysis of the outputs. For example, the aggregated personas component can ascertain which, among the personas, are most likely to take an action, and can optionally provide an explanation for why, e.g., based on output from the multiple trained AI models.

In some embodiments, the aggregated personas component can use agent-based modeling (ABM) to simulate the interactions of agents (or personas) represented by the AI models representing various segments of population. The outputs of the individual personas (e.g., of each AI model corresponding to a different persona) is provided to an agent-based modeling simulation, and through iterations, the agent-based modeling provides an output that represents the segment(s) (or persona(s)) most likely to satisfy a particular criterion (e.g., most likely to become a prospect)).

In some embodiments, the aggregated personas component can provide additional data of each of the segments (e.g., index, incidence, experience data, and/or context data) to the fine-tuned trained AI model. The aggregated personas component can provide the additional data of each segment to further improve the performance of the trained AI model, e.g., using RAG. By providing the additional data for each segment, the aggregated personas component can analyze a range of personas at once. For example, the aggregated personas component can rank segments according to which segment(s) are most likely to satisfy a criterion (e.g., most likely to be a good prospect for a particular product or service). In some embodiments, the aggregated personas component can compare and contrast the top and bottom converting segments (e.g., each represented by a different persona). The aggregated personas component can identify a ranked order of highest and lowest segment conversions, and can provide the ranking to the trained AI model, e.g., as additional data using RAG. With the additional data (including the index, incidence, experience data, context data, and/or ranking data), the trained AI model can provide an explanation for the differences between segments more likely to perform the conversion action and those less likely to perform the conversion action (e.g., the access of a website).

In some embodiments, an avatar component can generate a visual representation of a member of a segment. The avatar component can animate the avatar, and enable a user to interact with the trained AI model of the corresponding segment via the avatar, and/or interact with the trained AI model representing the aggregated personas. The avatar can correspond to the trained AI model from the summary component, the persona component, the persona plus component, and/or the aggregated personas component. The avatar for a persona may be a virtual person that moves, talks, and responds to prompts provided to one or more AI models associated with the persona. The avatar for a persona may vocalize and animate based on an output of the one or more AI models associated with the persona. In some embodiments, the multiple persona component can display multiple avatars in a UI, each representing a corresponding segment of a population, and enable a user of interact with the multiple trained AI models via the multiple avatars. In some embodiments, a user may engage with multiple avatars simultaneously or in parallel. For example, a user may provide a question, which may be processed by the AI models associated with each of the personas, and answers may be provided via each of the respective avatars.

Aspects of the present disclosure provide technical advantages over conventional systems including reduced usage of computing resources used for analyzing segment personas by generating, using AI, personas grounded in survey data, experience data and/or context. For example, aspects of the present disclosure enable the automation of the ingestion, organization, and synthesis of large-scale, heterogeneous data sources, including survey data, behavioral metrics, and/or campaign performance statistics, using advanced machine learning techniques. By leveraging retrieval augmented generation (RAG) in conjunction with large language models (LLMs), aspects of the present disclosure enable the processing of thousands of variables to generate highly detailed and realistic personas. This approach can enable the identification, quantification, and contextualization of segment characteristics using incidence and index metrics, which measure both the prevalence and distinctiveness of traits within a segment compared to the general population, resulting in more accurate and data-driven representations of consumer segments and overcoming the limitations of static or oversimplified persona models. Additionally, leveraging AI models that are fine-tuned with segment-specific data and enhanced with RAG techniques allows for efficient, on-demand synthesis of persona responses. For example, by caching persona states, using vectorized data retrieval, and conditioning outputs on both static and dynamic inputs, the system minimizes redundant computation and optimizes resource usage.

While embodiments of the present disclosure are described with respect to profiling user behavior with personas for the purpose of improving digital marketing, aspects of the present disclosure are suitable for any environment in which understanding and/or simulating human behavior is valuable. The conversational interface allows for dynamic, scenario-based exploration, supporting training, planning, and/or decision-making. For example, aspects of the present disclosure can be implemented to support healthcare and patient engagement, education and personalized learning, public policy and civic engagement, human resources and organizational development, and/or for any number of other environments that may benefit from interacting with and/or comparing population segments through AI-driven interactive digital personas. In healthcare, for example, aspects of the present disclosure can be used to create interactive patient personas that represent different demographic, behavioral, and/or health-related segments. These AI-driven personas can simulate patients with specific conditions, lifestyles, and/or treatment adherence patterns, allowing healthcare providers, researchers, and/or educators to interact with realistic patient profiles. As another example, in education, aspects of the present disclosure can be used to generate student personas representing various learning styles, backgrounds, and/or academic challenges. Educators, curriculum designers, and/or edtech developers can interact with the personas to test instructional strategies, develop inclusive materials, and/or simulate classroom dynamics. As another example, for human resources (HR) and organizational development, aspects of the present disclosure can be used to generate employee personas based on workforce analytics, engagement surveys, and/or performance data. HR professionals can use these personas to simulate workplace scenarios, test new policies, and/or design training programs, for example.

In situations where the system described herein collects personal information (e.g., campaign data), the system can incorporate anonymization protocols to remove personally identifiable information. For example, the anonymization process can employe a combination of mechanisms, such as one or more of data masking, pseudonymization, aggregation, and, where appropriate, differential privacy techniques. As an illustrative example, prior to ingestion into the systems data store or use in model training and persona generation, direct identifiers (e.g., names, addresses, and/or unique device identifiers) can be removed or replaced with randomly generated pseudonyms, and quasi-identifiers can be generalized or suppressed to prevent re-identification through data linkage. In some embodiments, data may be further aggregated at the segment or cohort level, such that only statistical summaries (e.g., incidence rates, index values, or behavioral patterns) are retained and utilized by the AI models, rather than individual-level records. The atomization process can be integrated into the system architecture as a preprocessing layer, operating prior to any data storage, RAG, and/or AI model interaction.

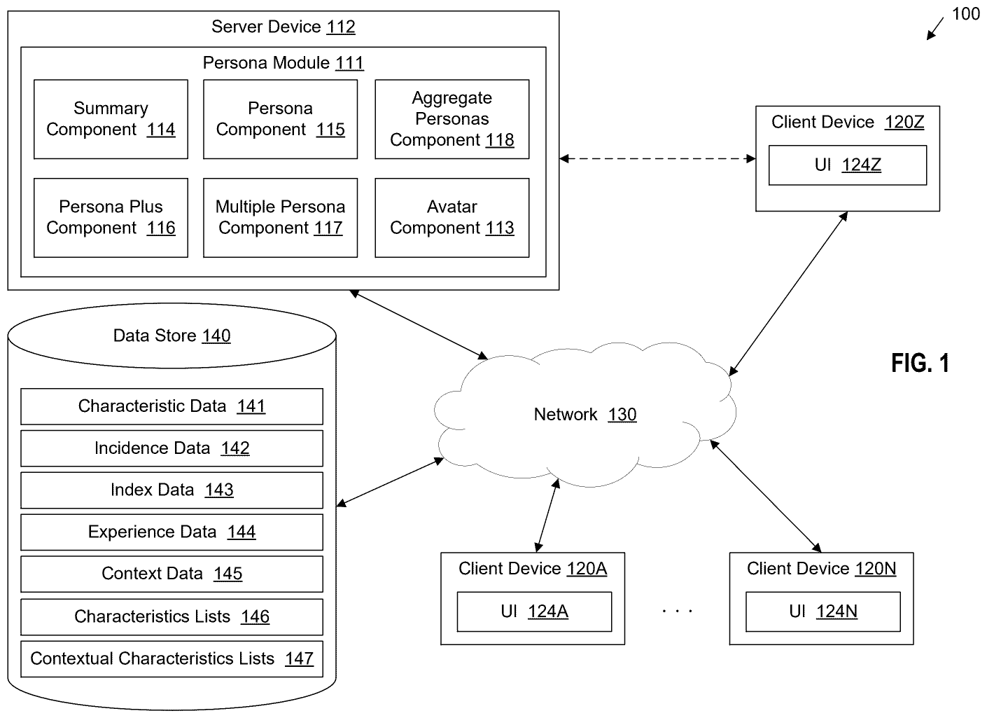

FIG. 1 illustrates an example of a system architecture 100 for implementations of the present disclosure. The system architecture 100 includes a server device 112, a data store 140, and/or client devices 120A-Z connected via a network 130. The network 130 may be one or more public networks (e.g., the Internet), private networks (e.g., a local area network (LAN) or wide area network (WAN)), or a combination thereof. The network 130 may include a wireless infrastructure, which may be provided by one or more wireless communications systems, such as Wi-Fi hotspot connected with the network 130 and/or a wireless carrier system that can be implemented using various data processing equipment, communication towers, etc. Additionally or alternatively, the network 130 may include a wired infrastructure (e.g., Ethernet). In some embodiments, the network 130 can be a single network.

In some embodiments, data store 140 can be a persistent storage that is capable of storing characteristic data 141, incidence data 142, index data 143, experience data 144, context data 145, characteristic list data 146, and/or contextual characteristic list data 147. In some embodiments, the incidence data 142, index data 143, experience data 144, context data 145, characteristic list data 146, and/or contextual characteristic list data 147 can correspond to ongoing campaign data, and can be updated as the ongoing campaign data is received. In some embodiments, the data can be updated on a predetermined schedule (e.g., every 2 hours, once a day, etc.), and/or as campaign performance data is received for a particular campaign. Data store 140 may be hosted by one or more storage devices, such as main memory, magnetic or optical storage based disks, tapes or hard drives, NAS, SAN, and so forth. In some implementations, data store 140 may be a network-attached file server, while in other embodiments data store 140 may be some other type of persistent storage such as an object-oriented database, a relational database, and so forth, that may be hosted by server device(s) 112, and/or client device(s) 120A-Z. In some embodiments, data store 140 may be hosted by or one or more different machines coupled to the server device 112, and/or user device 120A-Z, either directly and/or via network 130.

In some embodiments, characteristic data 141 includes data specific to each segment profile of a population. For example, characteristic data 141 can include an age range, employment status, home owner or home renter, social media engagement habits, car preference, online shopping habits, net worth, and/or notable engagements. As an illustrative example, values for the variables for a particular segment profile can be: young adults between 18 and 24 years old, primarily students, primarily home renters, frequent social media engagement, prefer compact cars, sensitive to car prices, primarily online shoppers, low net worth (e.g., under $25,000), and engaged in eco-friendly activities. The characteristic data 141 can be used to initiate a segment persona, as described with respect to summary component 114.

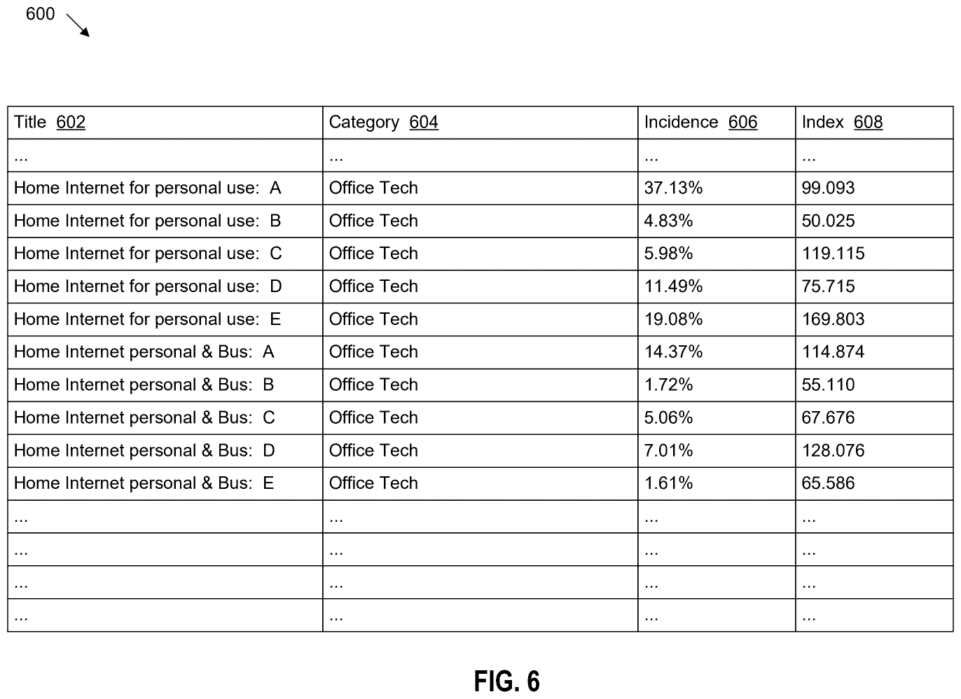

In some embodiments, incidence data 142 includes incidence values for each segment of the population. The incidence is an indication of the percentage of a characteristic value occurring within the segment. As an illustrative example, incidence data can reflect the percentage of the segment population that owns a home. In some embodiments, index data 143 includes index values for each segment of the population. The index is an indication of the percentage of a characteristic value occurring within the segment divided by the percent the characteristic value occurs within the overall population. Example incidence and index values are described with respect to FIG. 6.

In some embodiments, experience data 144 includes additional data for one or more segment profiles that reflects an action taken by a member of the corresponding segment. The action can be taken as a result of a particular campaign. The action can be a conversion, including, for example, making a purchase, filling out a form, downloading content, clicking on a specific link, engaging with content (e.g., watching a video, sharing a post, leaving a comment), registering for an event, starting a trial, etc.

In some embodiments, context data 145 includes additional data corresponding to a conversion. The context data 145 can include a reference to the campaign that the user interacted with (e.g., a reference to a particular content item that was displayed to the user as a part of a campaign). In some embodiments, the context data can include additional information about the campaign and/or the conversion. For example, if the experience data reflects the action of clicking on a link, the context data can include the universal resource locator (URL) of the link.

In some embodiments, the characteristic list data 146 can refer to a list of most defining segment characteristics along with key indicators (e.g., index data, incidence data) for one or more segments. The most defining segment characteristics can be those that are the top performing characteristics for a segment, or the characteristics that are present for a certain percentage of the segment (e.g., the top 10, or the top 10%). In some embodiments, the most defining segment characteristics can include the lowest performing characteristics (e.g., the bottom 10 or the bottom 10%), in addition to or instead of the top performing characteristics. The most defining segment characteristics can be identified using the index data and/or incidence data. In some embodiments, the characteristic list data 146 can be stored as a data structure such as a list, a linked list, an array, a queue, a tree, or any other type of data structure. In some embodiments, the characteristic list data 146 can be generated and/or updated by the persona component 115.

In some embodiments, the contextual characteristic list data 147 can refer to a list of the most defining segment characteristics along with key indicators (e.g., index data, incidence data), plus additional contextual data, campaign data, and/or experience data. In some embodiments, the contextual characteristic list data 147 can supplement and/or be an extension of the characteristic list data 146. In some embodiments, the contextual characteristic list data 147 can be stored as a data structure such as a list, a linked list, an array, a queue, a tree, or any other type of data structure. In some embodiments, the contextual characteristic list data 147 can be generated and/or updated by the persona plus component 116.

Each client device 120A-120Z may include one or more processing devices communicatively coupled to one or more memory devices and one or more I/O devices. The client devices 120A-120Z may be desktop computers, laptop computers, tablet computers, mobile phones (e.g., smartphones), or any suitable computing device. In some embodiments, the client devices 120A-120Z may each include a web browser and/or a client application (e.g., a mobile application or a desktop application) for viewing and/or interacting with AI-driven personas provided by the content server device 112 via user interfaces 124A-124Z supported by a web browser and/or a client application.

The server device 112 may be represented by one or more physical machines (e.g., server machines, desktop computers, etc.) that include one or more processing devices communicatively coupled to memory devices and input/output (I/O) devices. In some embodiments, server device 112 can include a persona module 111. The persona module 111 can be a software program hosted by a device (e.g., server device 112). The persona module 111 can include a summary component 114, a persona component 115, a persona plus component 116, a multiple persona component 117, an aggregated personas component 118, and/or an avatar component 113. The functions of the component 113-118 can be combined into fewer components, and/or separated in additional components.

In some embodiments, the summary component 114 can retrieve, receive, or otherwise identify a collection of data points from a variety of sources, including external sources such as campaign performance reports, web analytics, survey data, and/or other behavioral and/or demographic datasets (e.g., via network 130). In some embodiments, one or more of these sources may be internal sources, e.g., stored in data store 140. In some embodiments, the sources can include heterogeneous data, and the summary component 114 can ingest, organize, and/or synthesize the data from the various sources. In some embodiments, the summary component 114 can implement data mapping techniques, data transformation techniques, data cleansing techniques, and/or data preprocessing to prepare the data for analysis to generate a curated and/or structured summary of the collection of data points. The summary component 114 can store the curated and/or structured summary of the collection of data points as data structure(s) in data store 140, under the corresponding category e.g., as characteristic data 141 (e.g., demographic and/or behavioral attributes of segments), incidence data 142 (e.g., frequency of characteristics within a segment), index data 143 (e.g., relative likelihood of characteristics compared to the general population), experience data 144 (e.g., actions or events associated with segments), and/or context data 145 (e.g., additional situational and/or campaign-specific information). In some embodiments, the summary component 114 can implement one or more machine learning models to preprocess the data from the various sources. In some embodiments, the curated and/or structured summary of the collection of data points can serve as the foundational input for the generating, training, and/or operation of AI-driven personas. The curated and/or structured summary of the collection of data points can provide the structures information that enables the AI models to profile, simulate, and/or interact with the representative personas for different population segments.

In some embodiments, the data sources (whether external or internal) can provide the foundational inputs that characterize different population segments, including variables such as age, income, location, purchase history, website interactions, and/or campaign-specific actions (e.g., conversions, clicks, sign-ups, etc.), and so on. In some embodiments, the summary component 114 can ingest the raw data into a centralized data store (e.g., data store 140). In some embodiments, the summary component 114 can organize and/or structure the data into characteristic data 141, incidence data 142, index data 143, experience data 144, context data 145, characteristic lists data 146, and/or contextual characteristic list data 147.

In some embodiments, one of the data sources can include one or more images that are relevant to actions and/or campaign engagement of members of a segment (e.g., an image-based advertisement that a member of the persona segment has interacted with or that led the member of the persona to visit a particular webpage). The summary component 114 can implement computer vision techniques to analyze the one or more images to extract meaningful features from the one or more images, such as the presence of certain objects, text, branding elements, and/or visual themes. The analysis can include, for example, image classification, object detection, optical character recognition, and/or scene understanding. The output of the computer vision analysis can include structured representations of the visual content, such as tags, descriptive metadata, and/or summarized narratives of what the image depicts. The structured representation of the visual content can be stored as context data 145.

The summary component 114 can generate an initial, data-driven persona profile summary based on characteristic data 141, and optionally on performance data (e.g., incidence data 142, index data 143, experience data 144, and/or context data 145, if available). In some embodiments, the summary component 114 can fine-tune a foundational AI model (e.g., an LLM) using a general profile of a segment of a population. A foundational model can be a large, pre-trained model (such as a large language model) that is trained on vast, diverse datasets to learn general representations and patterns across a wide range of domains. In some embodiments, a foundational model can include deep neural network architectures, such as transformer networks for language and/or convolutional neural networks for vision tasks. Fine-tuning a foundational model can involve taking the pre-trained model and further training it on a smaller, domain-specific dataset to adapt its capabilities to a particular application or context. During fine-tuning, the foundational model's parameters can be adjusted to retain general knowledge from pre-training while specializing in the new domain.

In some embodiments, the summary component 114 can include or access a training engine that can fine-tune one or more AI models on data pertaining one or more segments of a population, to generate a specific, or targeted, model for each segment. In some embodiments, the fine-tuned training can be supervised, unsupervised, reinforced, or any other type of training. In some embodiments, the fine-tuning can include some elements of supervision, including learning techniques incorporating human or machine-generated feedback, undergoing training according to a set of guidelines, and/or training on a previously labeled set of data, etc. In some embodiments, the output of one or more of the AI models, during training, may be ranked by a user or automatically, according to a variety of factors (e.g., accuracy, acceptability, or any other metric useful in the fine-tuning portion of the training). The AI model can thus learn to favor these and any other factors relevant to users within an organization, or associated with a content item, when generating an output. In some embodiments, each AI model (e.g., the feature identifying AI model, the context AI model, and/or the insight AI model) can include one or more pre-trained or fine-tuned models.

The summary component 114 can generate and/or update the baseline persona representation that forms the basis for subsequent, more contextually nuanced persona generation and interaction. In some embodiments, the baseline persona generated by the summary component 114 can be stored in data store 140. In some embodiments, the summary component 114 can receive (or otherwise identify) raw and/or pre-processed segment data (e.g., characteristic data 141). Raw segment data can include unstructured or minimally structured data, such as direct survey responses, behavioral event logs, and/or campaign interaction records, which may include free-text answers, clickstream data, and/or raw numerical metrics. The summary component 114 can pre-process the raw data, e.g., by cleansing the data to remove inconsistencies, to handle missing values, and/or to standardize formats across sources. In some embodiments, the summary component 114 can further pre-process the data by applying feature extraction and/or feature engineering to identify and/or encode relevant variables (e.g., demographic attributes, psychographic scores, behavioral frequencies, and/or attitudinal markers) into structured fields. In some embodiments, the summary component 114 can pre-process the raw data to distill complex, multi-source data into a coherent, high-signal representation that can be used for persona generation.

In some embodiments, the raw and/or pre-processed data can include characteristic data 141, and optionally contrastive data that highlights how the segment differs from other segments. The received data can correspond to survey data, behavioral logs, and/or campaign reports, for example. In some embodiments, the data received (or identified) by summary component 114 can include, for example, survey data capturing demographic, psychographic, behavioral, and/or attitudinal information about individuals or segments within a population. In some embodiments, the received (or identified) data can include segment performance data, e.g., quantitative metrics that reflect how different population segments perform in relation to campaigns or actions (e.g., conversion rates, impression indices, incidence values, index values). In some embodiments, the received (or identified) data can include additional characteristic data aggregated from survey data and behavioral data. The additional characteristic data can include, for example, demographic details, lifestyle indicators, product or brand affinities, and/or other distinguishing features that define the segment's profile. In some embodiments, the received (or identified) data can include high-level contextual and/or experience data, such as campaign identifiers, content categories, and/or general engagement context to further refine the initial persona profile.

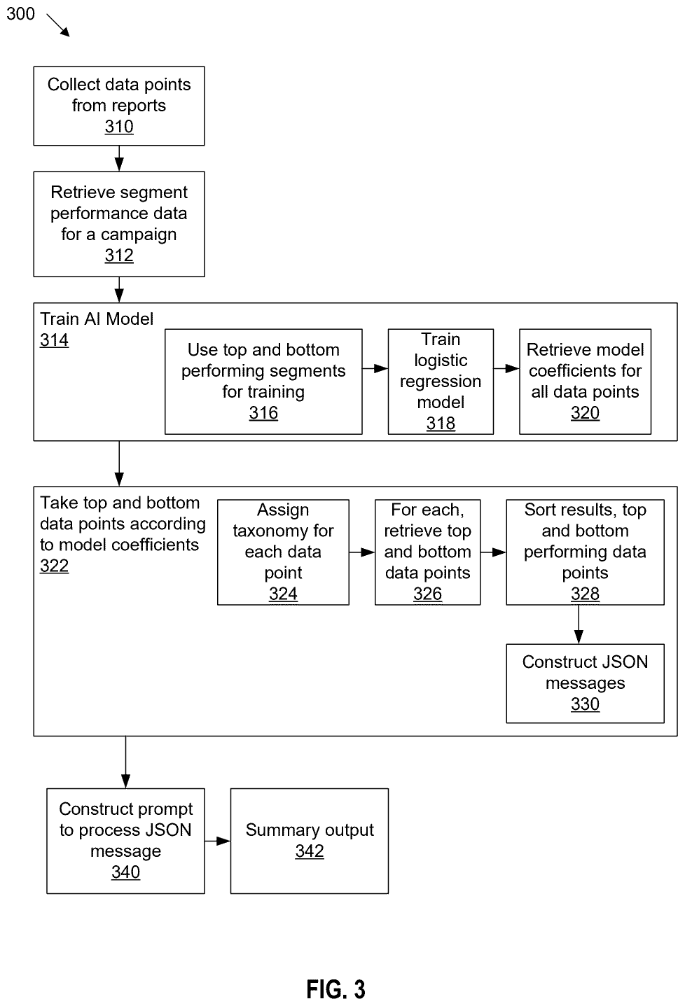

The summary component 114 can perform feature selection and data structuring on the received data to identify the most significant and/or differentiating features for each segment. For example, the summary component 114 can perform statistical analysis, such as ranking the segment features based on performance data, and selecting the features that best define the segment's unique profile. The summary component 114 can then use the identified and/or structured data to fine-tune a foundational AI model. The summary component 114 can construct structure prompts (e.g., in the form of JSON messages or other data schemas) that encapsulate the segment's defining characteristics. The summary component 114 can use the prompts to condition the foundational AI model, effectively embedding the segment's profile into the model's context window. The summary component 114 can thus output a fine-tuned trained AI model instance that can generate a specific persona for the segment, capable of responding to user queries in a manner consistent with the underlying data. The summary component 114 is further described with respect to FIG. 3.

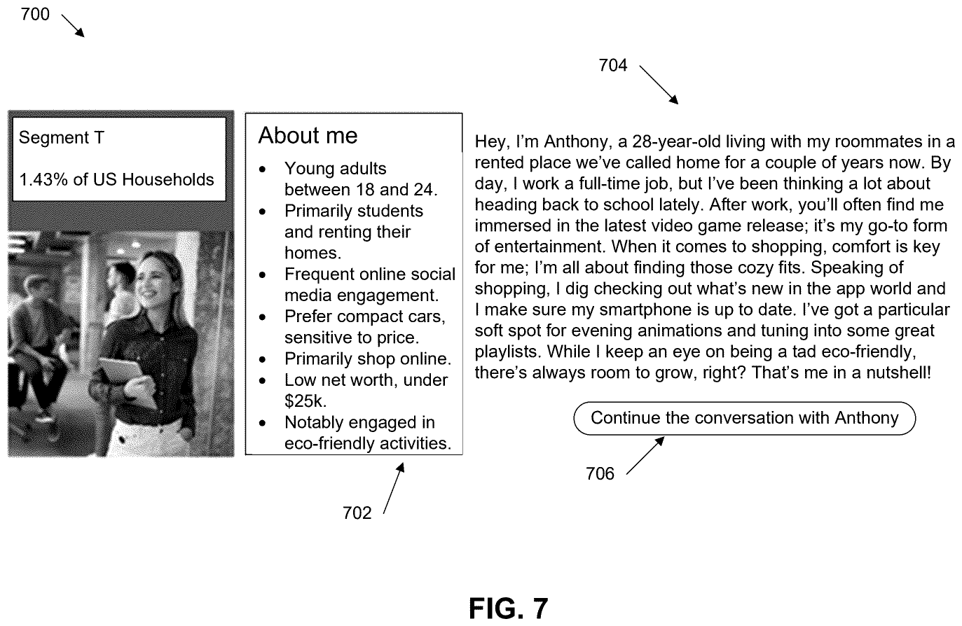

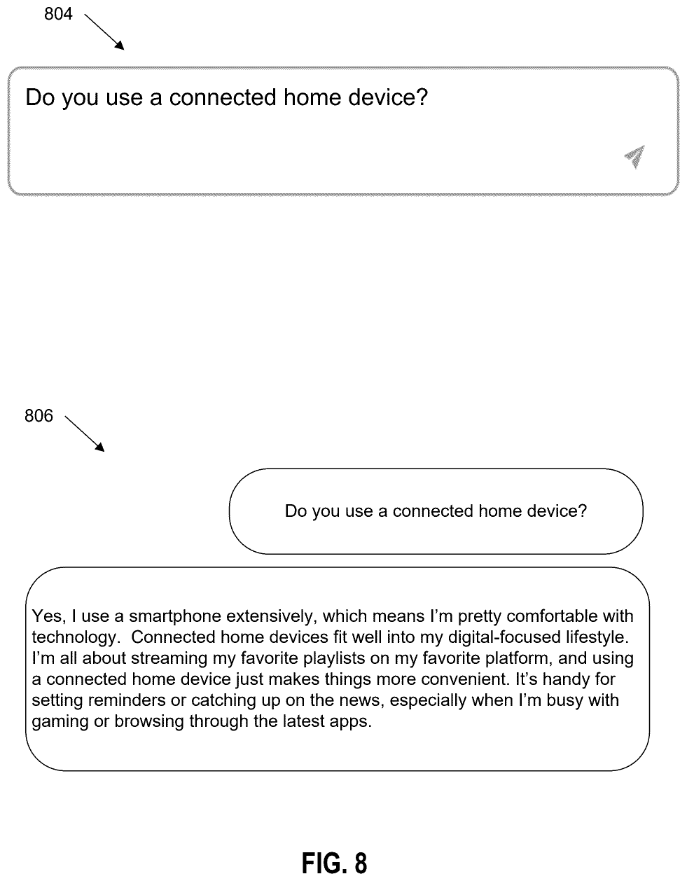

The persona component 115 can generate an interactive persona whose responses to inputs or prompts are dynamically conditioned on additional characteristic and/or behavioral data of specific consumer segments. In some embodiments, the persona component 115 can provide additional data to the fine-tuned trained AI model. The additional data can include, for example, index and incidence variables specific to the segment of the population associated with the fine-tined AI model. In some embodiments, the additional data can correspond to incidence data 142, index data 143, experience data 144, and/or context data 145. The persona component 115 can provide the additional data to improve the performance of the trained AI model, e.g., using retrieval-augmented generation (RAG). The persona component 115 can then provide the trained AI model, improved by the additional data, to a user device or client device (120A-Z). Alternatively or additionally, the persona component 115 may provide a client device 120A-Z with access to the trained AI model, which may reside on server device 112. The trained AI model enables a user to interact with the segment profile by using the conversational capabilities of an LLM with the answers conditioned on the data provided via the persona overall description and the incidence and index data tables, e.g., as described with respect to FIGS. 7-8.

In some embodiments, the persona component 115 can receive a user interaction (e.g., text-based and/or audio-based user input) from a user of a client 120A-Z. The user interaction can be a query or prompt for the AI-driven persona. The persona component 115 can provide the user interaction as input to the AI model corresponding to the persona. The persona component 115 can send the output of the AI model corresponding to the persona to the client 120A-Z (e.g., the client device 120A-Z from which the user interaction was received). The client device 120A-Z can provide the output received from the persona component 115 for display on the UI 124A-Z of the client device 120A-Z (e.g., via a web browser and/or a client application).

In some embodiments, the persona component 115 can receive (or otherwise identify) data from one or more reports. The reports can contain a wide array of variables and characteristics associated with different consumer segments, such as demographic information, lifestyle preferences, purchasing behaviors, and so on. In some embodiments, the data can correspond to characteristic data 140, incidence data 142, index data 143, experience data 144, and/or context data 145. The persona component 115 can extract significant characteristics for each segment, and can select to the top x characteristics (e.g., the top 10 characteristics) for each segment. In some embodiments, the persona component 115 can merge the top x characteristics to form a consolidated set of the most defining attributes for the segment. The persona component 115 can compile the selected top characteristics into a characteristics list that serves as a structured, data-rich summary of the segment, capturing the prevalence and distinctiveness of each characteristic. In some embodiments, the characteristics list can be a structured text file to store configuration data. For example, the characteristics list can include a dictionary of key-value pairs that the system can use to understand and manage the data. Thus, the characteristics list can be a structured summary of the most significant characteristics for a consumer segment, which can include key indicators such as incidence (e.g., users per 100 households) and/or index values that highlight how common and distinctive each characteristic is within the segment. The characteristics list can be stored as characteristic list data 146 of data store 140. In some embodiments, the persona component 115 can dynamically update the characteristics list, e.g., as more data becomes available.

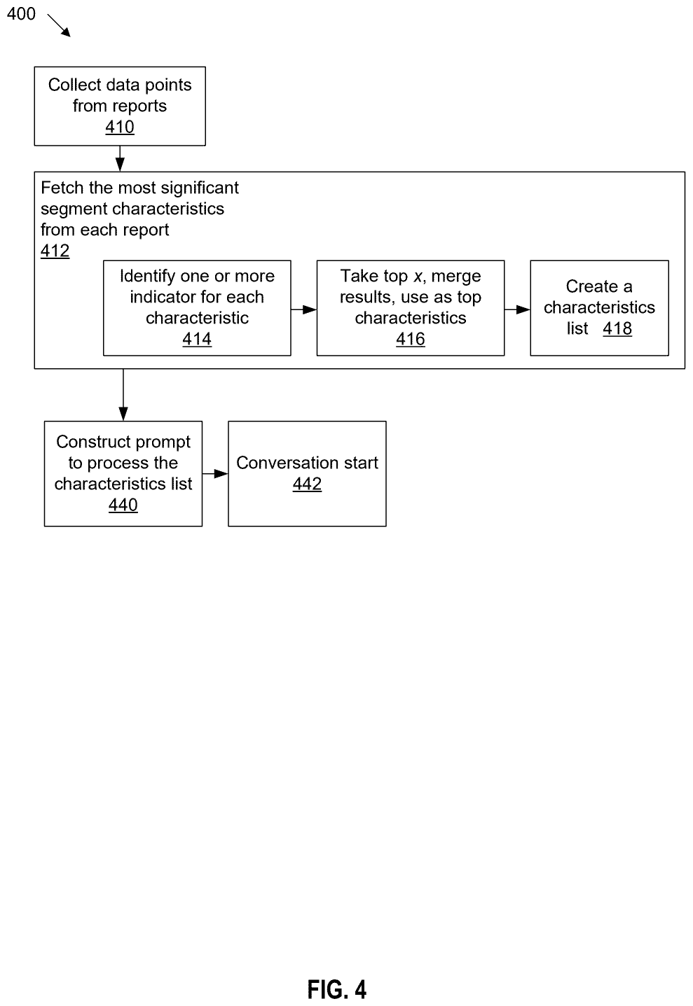

In some embodiments, the characteristics list can serve as a data-rich input for conditioning AI-generated personas so that their responses are grounded in real segment data. The characteristics list can function as the backbone of the AI-generated persona. By systematically capturing and presenting the most significant segment characteristics and their associated metrics (e.g., incidence, index, etc.), the characteristics list can ensure that every aspect of the persona's responses are consistent with the underlying data. Thus, the persona component 115 can use the characteristics list further refine the AI model. In some embodiments, the persona component 115 can provide the characteristics list to the trained AI model as RAG. The persona component 115 is further described with respect to FIG. 4.

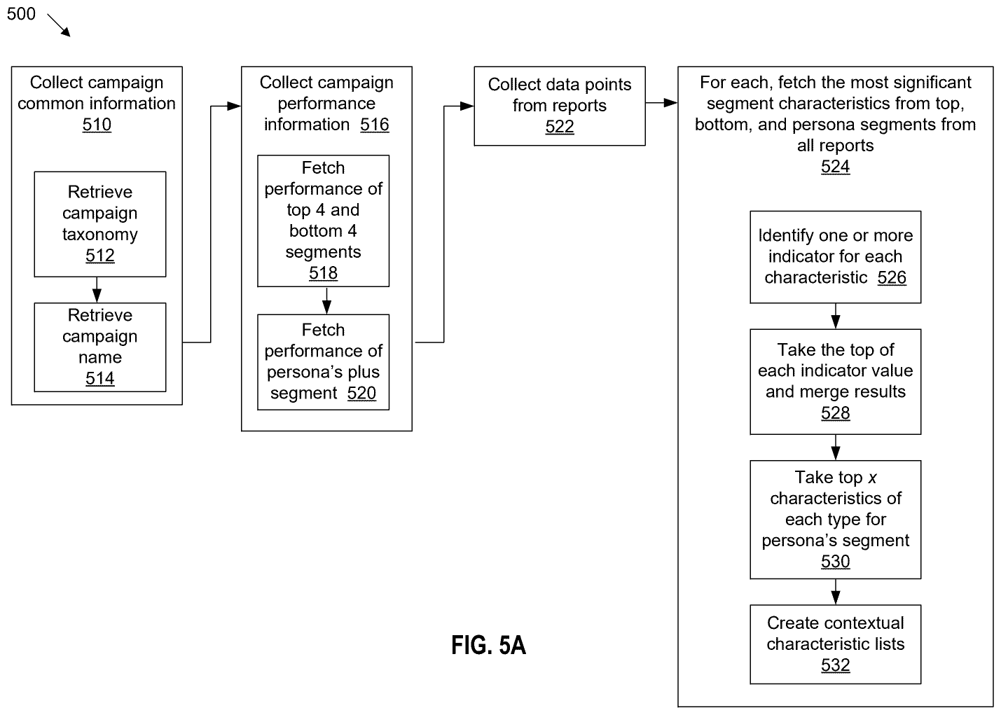

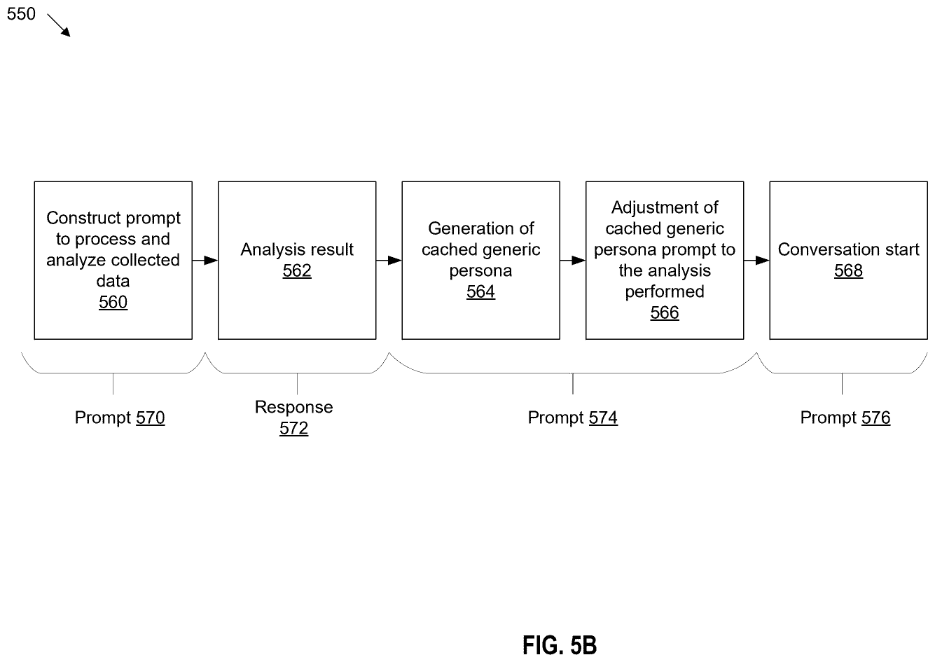

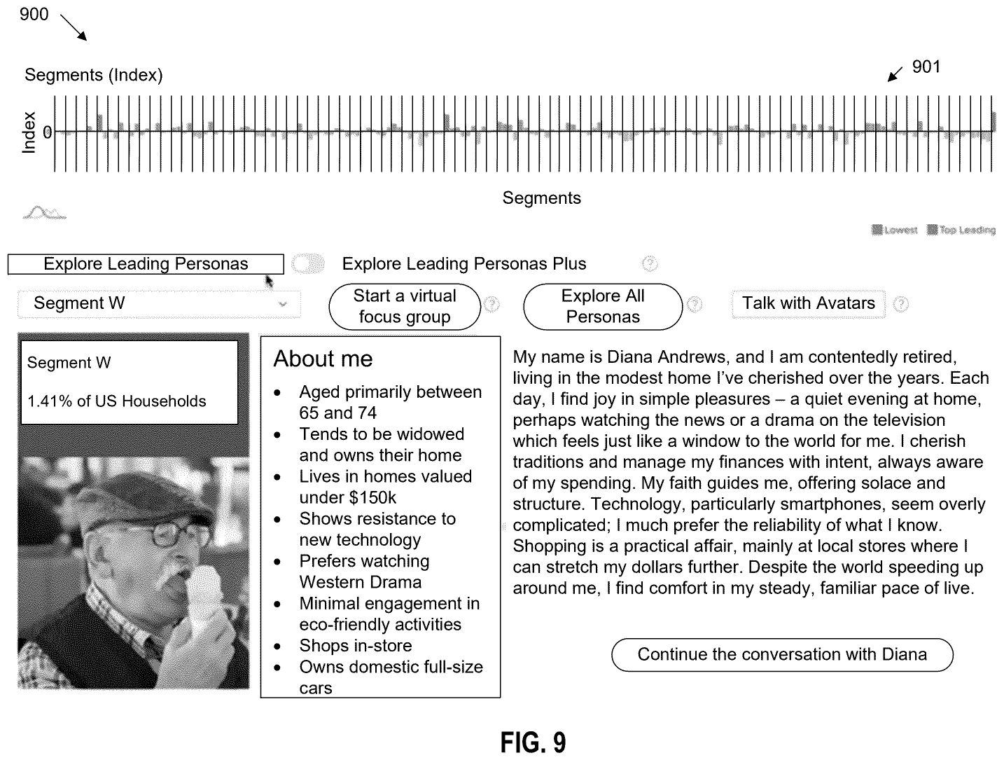

The persona plus component 116 can generate an enhanced interactive persona whose responses are dynamically conditioned on both static segment characteristics and recent, contextually relevant behaviors. In some embodiments, the persona plus component 116 can provide additional data, such as context data 145 and/or experience data 144, to the fine-tuned trained AI model, e.g., as generated by the summary component 114 and/or the persona component 115. In some embodiments, the persona plus component 116 can identify the most significant characteristics data (e.g., the top performing characteristics data, e.g., based on the corresponding index and/or incidence values) for each segment from the context data 145 and/or the experience data 144. The persona plus component 116 can merge the top results of the top performing characteristics to form a contextual characteristics list. The contextual characteristics list can be stored as contextual characteristic list data 147 of data store 140. The persona plus component 116 can provide the contextual characteristics list to further improve the performance of the trained AI model, e.g., using retrieval-augmented generation (RAG). Using the contextual characteristics list, the persona plus component 116 can construct a specialized prompt for the AI model. The prompt can instruct the AI model to assume the role of the persona, suing the provided data as grounding; condition the persona's responses on both the static segment data and the dynamic contextual and/or campaign data; and/or leverage RAG so that all outputs are consistent with the underlying data and context. In some embodiments, the persona plus component 116 can include an analysis phase, during which the AI's output is reviewed, and if necessary, adjusted to better align with the campaign context and/or behavioral data. During the analysis phase, the persona plus component 116 can fine-tune the persona's narrative or response style, verify that the persona's answers reflect recent action (e.g., purchasing a ticket, visiting a website) and the specific content that led to those actions, and/or contract the persona's behavior with that of other segments. The persona plus component 116 can then provide the trained AI model (or provide access to the trained AI model), improved by the additional data, the context data, and/or the experience data, to a user device or client device 120A-Z. The persona plus component 116 is further described with respect to FIGS. 5A-B. Thus, the output of the trained AI model(s) can be conditioned based on the specifics of the experience and context in which the persona is producing output, e.g., as described with respect to FIG. 9.

In some embodiments, the persona plus component 116 can receive a user interaction (e.g., text-based and/or audio-based user input) from a user of a client 120A-Z. The user interaction can be a query or prompt for the AI-driven persona. The persona plus component 116 can provide the user interaction as input to the AI model corresponding to the persona. The persona plus component 116 can send the output of the AI model corresponding to the persona to the client 120A-Z (e.g., the client device 120A-Z from which the user interaction was received). The client device 120A-Z can provide the output received from the persona plus component 116 for display on the UI 124A-Z of the client device 120A-Z (e.g., via a web browser and/or a client application).

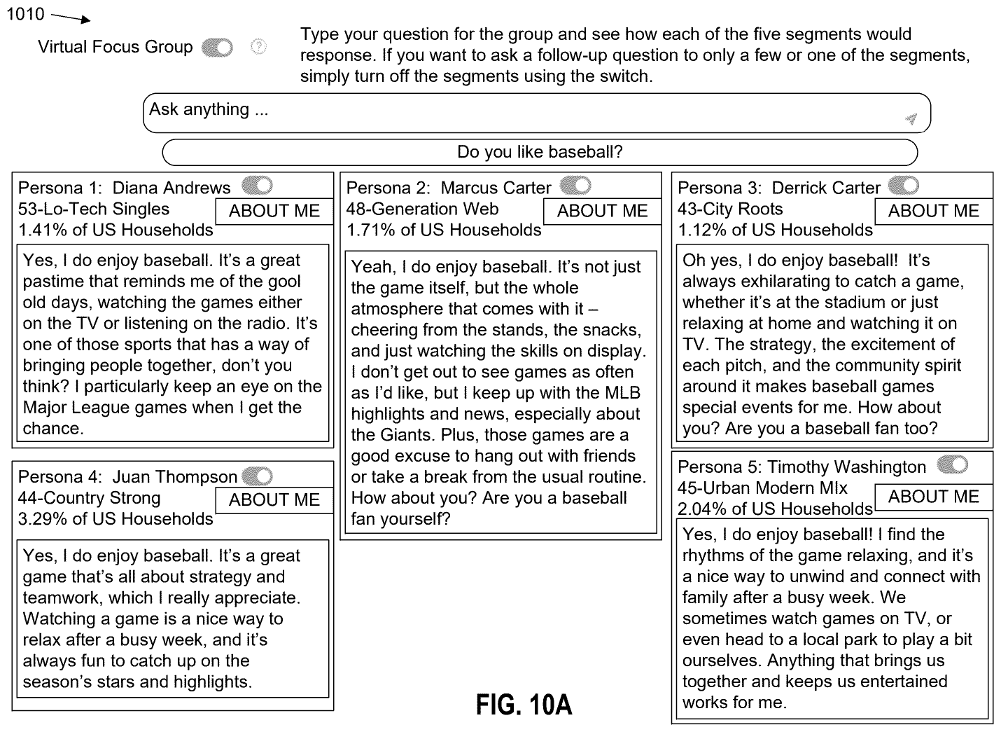

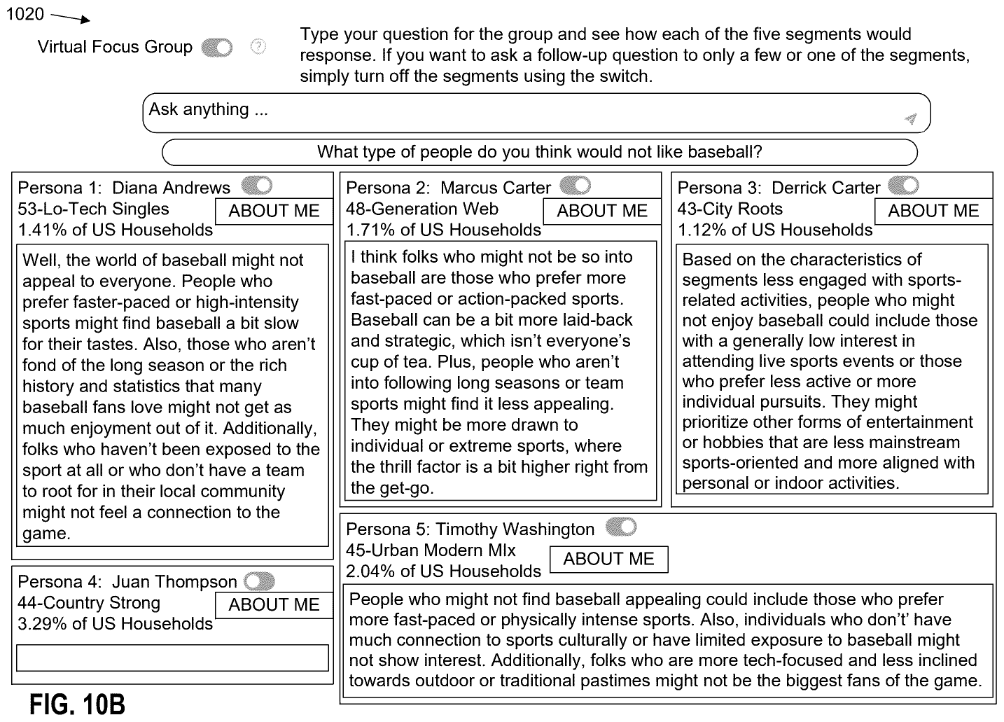

In some embodiments, the multiple persona component 117 can provide a user with access to multiple trained AI models, each trained AI model representing a specific segment of a population. That is, the multiple persona component 117 can enable a user to interact with, and optionally to compare, multiple AI-generated personas. The multiple persona component 117 can provide the same prompt to each of the trained AI models (each providing a different persona), and can provide the output of each trained AI model (e.g., of each persona), e.g., in a side-by-side display, enabling a user to compare each segment, e.g., as described with respect to FIG. 10. For example, the multiple persona component 117 can be used as a focus group for a particular product, wherein marketers, product developers, and/or researchers can observe how different segments might react to the same scenario, product, and/or campaign. In some embodiments, the multiple persona component 117 can enable the assembly of custom focus groups by allowing a user to select which personas to include, such as the top converting segments for a specific campaign or any combination of interests.

In some embodiments, the multiple persona component 117 can receive, as an interaction from a user of client device 102A-Z, a text-based and/or an audio-based input. The multiple persona component 117 can provide the input as a single query or prompt to each of the trained AI models. The multiple persona component 117 can receive an output from each trained AI model, and can provide the outputs for presentation on a UI 124A-Z of the corresponding client device 120A-Z.

In some embodiments, the multiple persona component 117 can receive a user interaction (e.g., text-based and/or audio-based user input) from a user of a client 120A-Z. The user interaction can be a query or prompt for the AI-driven personas. The multiple persona component 117 can provide the user interaction as input to the multiple AI models corresponding to the multiple personas. The multiple persona component 117 can send the outputs of the AI models corresponding to the personas to the client 120A-Z (e.g., the client device 120A-Z from which the user interaction was received). The client device 120A-Z can provide the outputs received from the multiple persona component 117 for display on the UI 124A-Z of the client device 120A-Z (e.g., via a web browser and/or a client application).

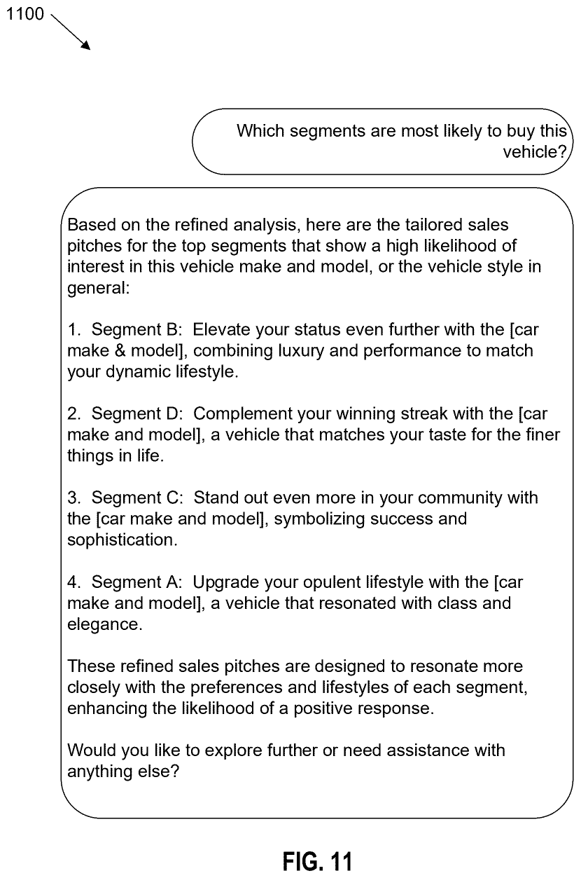

In some embodiments, the aggregated personas component 118 can combine the output of multiple trained AI models, each AI model representing a specific segment (e.g., each AI model representing a different persona). The aggregated personas component 118 can provide an analysis of a range of personas at once. The aggregated personas component 118 can provide an input to multiple trained AI models, each corresponding to a different persona, and can combine the outputs from each trained AI model to generate an aggregated output. In some embodiments, the aggregated personas component 118 can compare the outputs of the multiple trained AI models, and provide an analysis of the outputs. For example, the aggregated personas component 118 can ascertain which, among the personas, are more likely to take an action, and can optionally provide an explanation for why, e.g., based on output form the multiple trained AI models. An illustrative example of the aggregated personas component 118 is described with respect to FIG. 11.

In some embodiments, the aggregated personas component 118 can use agent-based modeling (ABM) to simulate the interactions of agents (or personas), represented by the AI models representing various segments of population. The aggreged personas component 118 can employ ABM as an advanced analytical layer that simulates the interactions and/or behaviors of multiple AI-generated personas, each persona representing a distinct segment of the population. Each persona can be instantiated as an autonomous agent, grounded in characteristic, incidence, index, experience, and/or contextual data specific to its segment. The aggregated personas component 118 uses ABM to simulate the interaction of persona agents with one another and with simulated environmental factors, such as marketing campaigns or product offerings, in a virtual environment. Through iterative simulations, the aggregated personas component 118 can simulate how the agents respond to various stimuli and make decisions, thereby modeling complex, emergent patterns of consumer behavior.

In some embodiments, the aggregated personas component 118 can provide the outputs of the individual personas (e.g., of each AI model corresponding to a different persona) to an agent-based modeling simulation engine, and through iterations, the agent-based modeling simulating engine can provide an output that represents the segment(s) (or persona(s)) most likely to satisfy a particular criterion (e.g., most likely to become a prospect). The engine can orchestrate interactions among the agents, allowing for the exploration of scenarios such as the diffusion of product adoption, the spread of preferences, and/or the impact of targeted messaging across different segments. The aggregated personas component 118 can aggregate and analyze the results of the simulations to identify which personas or segments are most likely to satisfy specific criteria, such as becoming high-value prospects or responding positively to a campaign. Additionally, in some embodiments, the aggregated personas component 118 can provide an explanation for the outcomes by leveraging the underlying data and the conversational capabilities of the trained AI models, offering insights into the drivers of segment-level behavior.

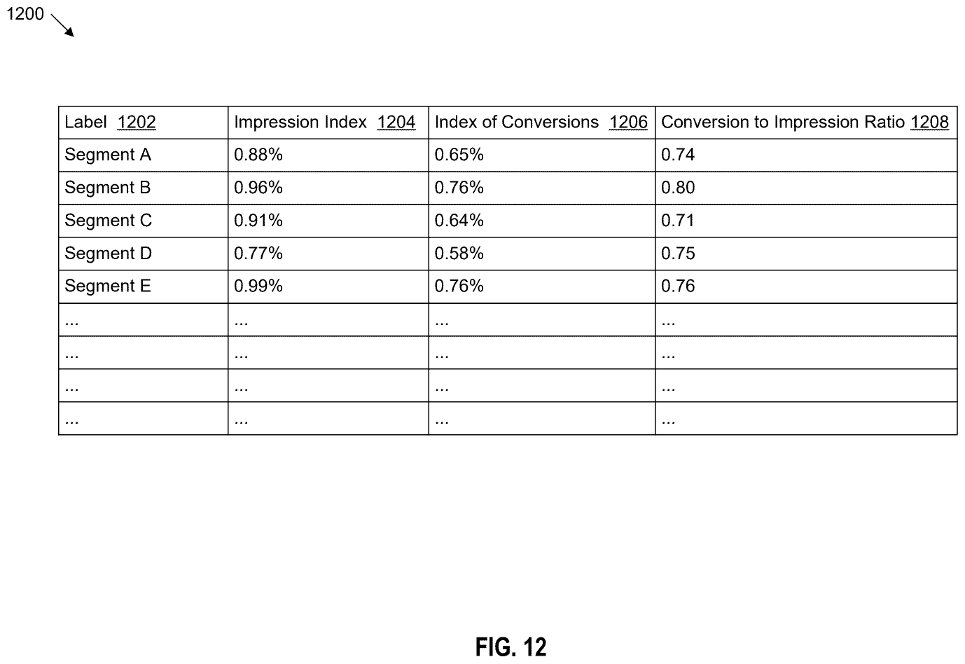

In some embodiments, the aggregated personas component 118 can provide additional data of each of the segments (e.g., index, incidence, experience data, and/or context data) to the fine-tuned trained AI model. The aggregated personas component 118 can provide the additional data of each segment to further improve the performance of the trained AI model, e.g., using RAG. By providing the additional data for each segment, the aggregated personas can analyze a range of personas at once. In some embodiments, the aggregated personas component 118 can compare and contrast the top and bottom converting segments (e.g., each represented by a different persona). For example, the aggregated personas component 118 can identify a ranked order of highest and lowest segment conversions, and can provide the ranking to the trained AI model, e.g., as additional data using RAG. An illustrative example of the ranking is described with respect to FIG. 12. With the additional data (including the index, incidence, experience data, context data, and/or ranking data), the trained AI model can provide an explanation for the differences between segments more likely to perform the conversion action and those less likely to perform the conversion action (e.g., the access of a website).

In some embodiments, the aggregated personas component 118 can receive a user interaction (e.g., text-based and/or audio-based user input) from a user of a client 120A-Z. The user interaction can be a query or prompt for the AI-driven persona(s). The aggregated personas component 118 can provide the user interaction as input to the AI model(s) corresponding to the persona(s). The aggregated personas component 118 can send the output of the AI model(s) corresponding to the persona to the client 120A-Z (e.g., the client device 120A-Z from which the user interaction was received). The client device 120A-Z can provide the output received from the aggregated personas component 118 for display on the UI 124A-Z of the client device 120A-Z (e.g., via a web browser and/or a client application).

In some embodiments, the avatar component 113 can generate a visual representation of a member of a segment. In some embodiments, the avatar component 113 can generate an avatar through a multi-step pipeline. The pipeline can include identifying input data, such as images, videos, three-dimensional (3D) scans, and/or manual customization parameters. In some embodiments, the input data can correspond be stored in data store 140, and can correspond to a representative member of a segment. The input data can be mapped to a predefined avatar model, e.g., represented by a model file stored in data store 140. The model file can include skeletal structure to allow animation and articulation. The avatar component 113 can apply texture mapping to provide surface detail. In some embodiments, the avatar component 113 can simulate lighting, skin, hair, and/or clothing effects. The avatar component 113 can use machine learning models (e.g., generative adversarial networks (GANs) or diffusion models) to stylize the avatar. The avatar component 113 can render the generated avatar using a graphics engine to transform the 3D data into 2D images for display. The avatar component 113 can rendering of the avatar with audio output corresponding to the output of the trained AI model.

In some embodiments, the avatar component 113 can animate the avatar by generating a visual representing of a member of a segment, which can be displayed as a virtual person that moves, talks, and/or responds to user prompts. The animation of the avatar can make the avatar appear lifelike and interactive, enhancing the realism and/or engagement of the digital interactive persona experience. When a user interacts with the avatar (e.g., through voice and/or text input), the avatar component 113 can process the input using the trained AI model representing the segment's persona. The avatar component 113 can then use the persona's response (e.g., output from the AI model) to drive the avatar's animation. The avatar component 113 can animate the avatar's posture, facial expressions, body movements, and/or mouth movements to synchronize with the generated speech and/or text response. For example, if the user provide an audio-based question, the avatar can respond verbally. The avatar component 113 can use a text-to-speech algorithm to vocalize the persona's response and animate the avatar's mouth and facial features to match the spoken words. In some embodiments, the avatar component 113 can animate the avatar to exhibit appropriate gestures, head movements, or changes in posture that correspond to the emotional tone and/or content of the response, such as smiling, nodding, displaying surprise, etc. The avatar component 113 can provide the animation by producing a video stream that visually represents the persona as it speaks (e.g., outputs an audio-based response to a query) and/or reacts during the conversation. The avatar component 113 can enable the video stream to play in the UI of the client 120A-Z. The avatar component 113 can synchronize the video stream with the audio and/or text-based response.

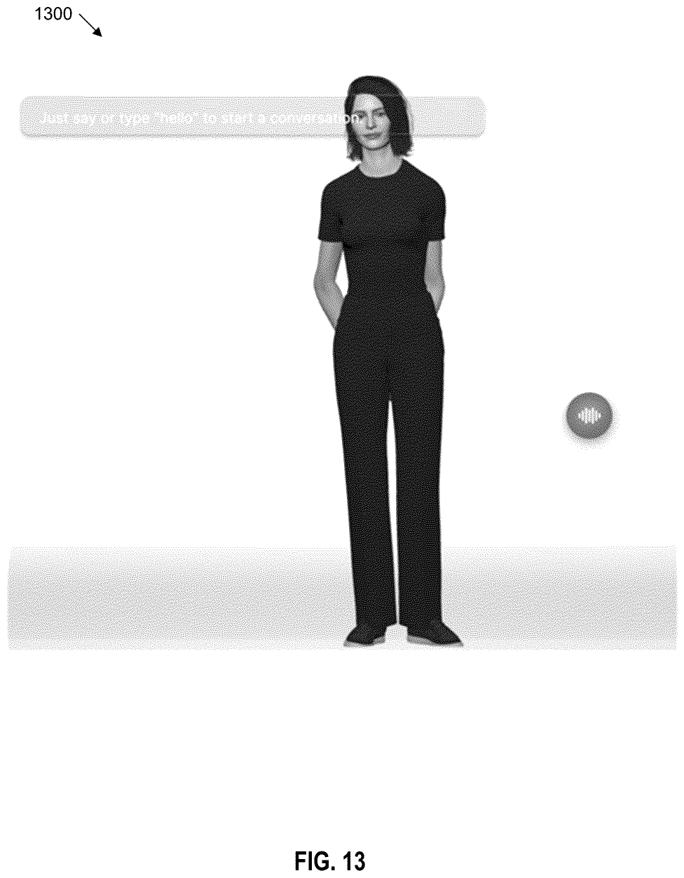

In some embodiments, the avatar component 113 can enable a user to interact with the trained AI model of the corresponding segment via the avatar, e.g., as described with respect to FIG. 13. The avatar can correspond to the trained AI model from the summary component 114, the persona component 115, the persona plus component 116, and/or the aggregated personas component 118. In some embodiments, the multiple persona component 117 can display multiple avatars in a UI, each representing a corresponding segment, and enable a user to interact with the multiple trained AI models via the multiple avatars. In some embodiments, voice or text input may be provided by a user, which may be processed by trained AI models representing each of the personas (e.g., optionally after performing speech to text conversion). The trained AI models may then output answers to the voice or text input in accordance with the respective personas provided by the different trained AI models.

In some embodiments, the avatar component 113 can receive a user interaction (e.g., text-based and/or audio-based user input) from a user of a client 120A-Z. The user interaction can be a query or prompt for the AI-driven persona(s). The avatar component 113 can provide the user interaction as input to the AI model(s) corresponding to the persona(s). The avatar component 113 can send the output of the AI model(s) corresponding to the persona to the client 120A-Z (e.g., the client device 120A-Z from which the user interaction was received). The client device 120A-Z can provide the output received from the avatar component 113 for display on the UI 124A-Z of the client device 120A-Z (e.g., via a web browser and/or a client application).

In some embodiments, persona module 111 can gather characteristics about target audiences. Such characteristics can include demographic information (such as, an age or a gender), contextual information, historical (or user behavioral) features (such as, a number of impressions, time since the last impression, a number of clicks), experience information, and so on.

In some embodiments, the server device 112 (e.g., persona module 111) can include a training set generator that can generate training data (e.g., a set of training inputs and target outputs) to train an AI model. The AI model may have already been trained, and further training may be performed to tailor the AI model to a particular persona in some embodiments. In some embodiments, the training data set(s) can be stored in data store 140. In some embodiments, the training data sets can include a corpus of data, such as textual data, image data, and/or audio data. The training data sets can also include mapping data that maps the training inputs to target outputs. In some embodiments, the AI model can be a pre-trained foundational model, and a training engine can fine-tune the AI model on data pertaining to the segment profiles, to generate more specific, or targeted, models. In some embodiments, the fine-tuned training can be supervised, unsupervised, reinforced, or any other type of training. In some embodiments, the fine-tuning can include some elements of supervision, including learning techniques incorporating human and/or machine-generated feedback, undergoing training according to a set of guidelines, or training on a previously labeled set of data, etc. In some embodiments, the output of the AI model, during training, may be ranked by a user or automatically, according to a variety of factors (e.g., accuracy, acceptability, or any other metric useful in the fine-tuning portion of the training). The AI model can thus learn to favor these and any other factors relevant to users within an organization, or associated with a content item, when generating an output. In some embodiments, the AI model can include one or more pre-trained or fine-tuned models.

In some embodiments, the persona module 111 can identify and/or perform actions in response to user interactions with the persona(s) and/or in response to observed persona behaviors. For example, in some embodiments, when a user interacts with an AI-driven persona (e.g., provided by the persona component 115, the persona plus component 116, the multiple persona component 117, the aggregate persona component 118, and/or the avatar component 113), such as by asking about preferences, motivations, and/or likely actions, the persona module 111 can trigger a feedback loop that drives actions aligned with consumer attitudes and/or behaviors represented by the persona. For example, if a user queries a persona about its likelihood to purchase a specific product, the persona module 111 can automatically log the interaction and flag the segment for future marketing campaigns based on the persona's output. For example, if the persona responds that it is very likely that it would buy the specific product, the persona module 111 can flag the segment (e.g., update the characteristic data 141 corresponding to the segment) as a high-potential target for future marketing campaigns. In some embodiments, the persona module 111 can recommend and/or initiate the creation of tailored marketing content, such as drafting email templates or digital advertisements that highlight features that resonate with that segment's preferences.

As another example, when a user asks multiple personas a comparative question (e.g., “which of you like most likely to attend a baseball game?), the persona module 111 can aggregate and analyze the responses to identify top-converting segments. Based on this analysis, the persona module 111 can adjust campaign targeting parameters, such as reallocating ad spend toward high-index segments, or updating lookalike audience models for digital advertising platforms. In some embodiments, the persona module 111 can generate reports and/or dashboards that visualize these findings, providing actionable insights to marketing and/or product teams.

As another example, the persona module 111 can detect that a persona (or a group of personas) consistently expresses disinterest or negative sentiment toward a product or campaign. In such instances, the persona module 111 can generate an actionable insight, such as a recommendation for creative refreshes, offer adjustments, and/or channel shifts. For example, if a persona indicates a preference for symphony tickets over baseball games, the persona module 111 can recommend cross-promotional opportunities or suggest reallocating resources to more receptive segments.

As another example, when a persona is conditioned on a experience data (e.g., having completed a purchase or visited a particular website), the persona module 111 can use the experience data (and optionally the corresponding context data) to trigger a follow-up action, such as adjust a targeting parameter of a campaign. For example, if a persona representing a segment that just bought a ticket to a baseball game is asked about its motivations, the persona module 111 can extract the key drivers form the conversation (e.g., “I was drawn in by the player-focused ad) and can update campaign attribution models or recommend optimizations to creative assets. For example, the persona module 111 can suggest new campaign variants, such as increasing the frequency of player-focused ads for that segment, and/or for similar segments.

In some embodiments, the actionable insights and/or follow-up actions (e.g., targeting parameters adjustments) can be provided by the trained AI model(s) described throughout. For example, the training dataset used to train the AI model(s) can include actionable insights and/or follow-up actions that correspond to certain persona responses, and the AI model(s) can then provide, along with the output corresponding to a persona, actionable insight(s) and/or follow-up actions. In some embodiments, the persona module 111 can automatically implement the actionable insights and/or follow-up actions.

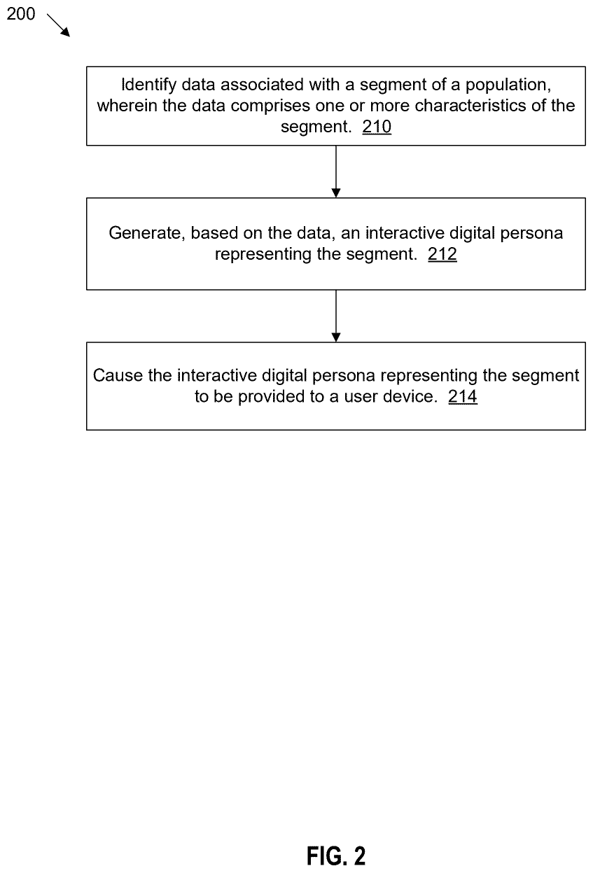

FIG. 2 depicts a flow diagram of a method 200 for generating an interactive persona representing a segment of a population, in accordance with one or more aspects of the present disclosure. The method 200 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 200 may be performed by the persona module 111 of FIG. 1. The method 200 may be executed by one or more processing devices of the server 112, to be presented to client devices 120A-120Z.

For simplicity of explanation, the method 200 of this disclosure is depicted and described as a series of acts. However, acts in accordance with this disclosure can occur in various orders and/or concurrently, and with other acts not presented and described herein. Furthermore, not all illustrated acts may be required to implement the method 200 in accordance with the disclosed subject matter. In addition, those skilled in the art will understand and appreciate that the method 200 could alternatively be represented as a series of interrelated states via a state diagram or events. Additionally, it should be appreciated that the method 200 disclosed in this specification are capable of being stored on an article of manufacture (e.g., a computer program accessible from any computer-readable device or storage media) to facilitate transporting and transferring such method to computing devices.

At operation 210, the processing logic identifies data associated with a segment of a population. The data can include one or more characteristics of the segment. The data can correspond to characteristic data 141 of data store 140 of FIG. 1, for example. In some embodiments, the one or more characteristics can include an age range, a employment status, a home ownership status, social media engagement habits, car preference, online shopping habits, net worth, income, and/or notable engagements. In some embodiments, the data can be identified from a data store (e.g., data store 140). Additionally or alternatively, the data can be received from an external source, such as campaign performance reports, web analytics, survey data, and/or other behavioral and/or demographic datasets.

At operation 212, the processing logic generates, based on the data, an interactive digital persona representing the segment. In some embodiments, the processing logic can provide the data to a trained AI model configured to generate the interactive digital persona. The data can supplement, using RAG, the trained AI model, and the trained AI model can generate the interactive digital persona. In some embodiments, the interactive digital persona generated at operation 212 can correspond to the summary component 114 of FIG. 1.

In some embodiments, the trained AI model can be or include one or more of decision trees, random forest models, support vector machines, neural networks, large language models (LLMs) or other types of machine learning models. In one embodiment, the trained AI model can or include be one or more artificial neural networks (also referred simply as a neural network). The artificial neural network can be, for example, a convolutional neural network (CNN) or a deep neural network. In one embodiment, processing logic performs supervised machine learning to train the neural network.

In some embodiments, the trained AI model can be generative AI model that is a pre-trained foundational model, such as a large language model (LLM). The processing logic can provide the data as part of a retrieval-augmented generation (RAG) approach in some embodiments.

In some embodiments, the processing logic can identify index data and/or incidence data associated with the segment. The index data and/or incidence data can correspond to index data 143 and incidence data 142, respectively, of FIG. 1. In some embodiments, the processing logic can identify the index data and/or incidence data from a data store (e.g., data store 140). Additionally or alternatively, the index data and/or incidence data can be received from an external source, such as campaign performance reports, web analytics, survey data, and/or other behavioral and/or demographic datasets. The index data and/or the incidence data can be provided to a trained AI model configured to generate the interactive digital persona. The index data and/or incidence data can supplement, using RAG, the trained AI model, and the trained AI model can generate the interactive persona. In some embodiments, the interactive digital persona generated at operation 212 can correspond to the persona component 115 of FIG. 1.

In some embodiments, the processing logic can identify additional data associated with at least a subset of the segment. The additional data can include, for example, context data and/or experience data (e.g., context data 145 and experience data 144 of FIG. 1). In some embodiments, the processing logic can identify the index data and/or incidence data from a data store (e.g., data store 140). Additionally or alternatively, the index data and/or incidence data can be received from an external source, such as campaign performance reports, web analytics, survey data, and/or other behavioral and/or demographic datasets. The experience data can reflect one or more actions taken by one or more members of the segment, and the context data can reflect contextual information a corresponding action of the one or more actions. The processing logic can provide the additional data to a trained AI model configured to generate the interactive digital persona. The data can supplement, using RAG, the trained AI model, and the trained AI model can generate the interactive digital persona. In some embodiments, the interactive digital persona generated at operation 212 can correspond to the persona plus component 116 of FIG. 1. In some embodiments, the experience data reflects one or more actions taken by one or more members of the segment. In some embodiments, the context data reflects contextual information of a corresponding action of the one or more actions.

At operation 214, processing logic can cause the interactive digital persona representing the segment to be provided to a user device (e.g., client device 120A-Z of FIG. 1). In some embodiments, processing logic can provide a graphical user interface (GUI) for display on a UI of the user device. The GUI can include a first GUI portion to receive an interaction of a user of the user device, and a second GUI portion to display a response generated by a trained AI model (e.g., the trained AI model that generates the interactive digital persona). An example of the GUI is described with respect to FIGS. 8, 10A-B, 11, and/or 13. In some embodiments, the GUI can include an avatar representing a member of the segment, e.g., as described with respect to FIG. 13. An avatar can refer to a visual representation of a member of a segment persona. In some embodiments, processing logic can generate and/or provide the avatar for presenting in the UI, e.g., as described with respect to the avatar component 113 of FIG. 1.

In some embodiments, processing logic can receive an interaction of a user of the user device. The interaction can be associated with the interactive digital persona. In some embodiments, the interaction can include a textual input and/or an audio input. That is, the user of the user device can provide a written input to interact with the interactive digital persona, and/or can provide an audio input (e.g., can talk to) to interact with the interactive digital persona. The interaction can be received via the GUI of the user device, e.g., as described with respect to FIGS. 8, 10A-B, 11, and/or 13. The processing logic can provide the interaction as input to the trained AI model (e.g., to the trained AI model trained to generate the interactive digital persona). In some embodiments, the processing logic can convert an audio-based input to text, e.g., using a speech-to-text conversion algorithm. The processing logic can receive an output from the trained AI model. The output can include a response of the interactive digital persona. The response can be a response to the interaction received from the user. The processing logic can provide, for display in the user interface, the output. The output can be textual and/or audio. In some embodiments, processing logic can convert a text-based output to audio, e.g., using a text-to-speech conversion algorithm. In some embodiment, the processing logic can provide the output of the trained AI model to the user device in the same format (e.g., text or audio) in which the interaction was received. In some embodiments, the processing logic can provide the output of the trained AI model to the user device in a format indicated by a user setting.

In some embodiments, the processing logic can implement the functionality of the multiple persona component 117 of FIG. 1. The processing logic can identify one or more trained AI models, each one corresponding to a distinct segment of a plurality of segments of the population. The plurality of segments can include the segment of the population (e.g., of operation 212). Each of the one or more trained AI models can be trained to generate a corresponding interactive digital persona, corresponding to the distinct segment of the population. The processing logic can receive an interaction of a user of the user. The interaction can be associated with the interactive digital persona, and the interaction can include a textual input and/or an audio input. The processing logic can provide the interaction as input to the one or more trained AI models. In some embodiments, the processing logic can convert an audio-based input to text, e.g., using a speech-to-text algorithm, and the processing logic can then provide the generated text-based input as input to the one or more trained AI models. The processing logic can receive one or more outputs from the one or more trained AI models each of the one or more outputs is received from a corresponding trained AI model, and each of the one or more trained AI models corresponds to a distinct interactive digital persona. The processing logic can provide, for display on a user interface of the user device, the one or more outputs. Each of the one or more outputs can be a textual output or an audio output. In some embodiments, processing logic can convert a text-based output to audio, e.g., using a text-to-speech conversion algorithm. In some embodiment, the processing logic can provide the output of the trained AI model to the user device in the same format (e.g., text or audio) in which the interaction was received. In some embodiments, the processing logic can provide the output of the trained AI model to the user device in a format indicated by a user setting.

In some embodiments, the processing logic can implement the functionality of the aggregate personas component 118 of FIG. 1. The processing logic can combine the output of multiple trained AI models, each trained AI model representing a different persona. In some embodiments, the processing logic can analyze the combined output of the multiple trained AI models. In some embodiments, the processing logic can use agent-based modeling to analyze the combined output of the multiple trained AI models, and can provide the results of the analysis for presentation in the GUI of the user device. An example GUI of aggregated output is described with respect to FIG. 11. The processing logic can receive an interaction from a user (e.g., as described above), and the processing logic can provide the interaction as input to the multiple trained AI models. The processing logic can combine the output of the trained AI models. IN some embodiments, the combined output can be provided for presentation in the GUI of the user device. Additionally or alternatively, the processing logic can analyze the output, and provide the result of the analysis for presentation in the GUI (e.g., in addition to the combined output or in place of the combined output).

In some embodiments, processing logic can generate, based on an output of the interactive digital persona, an actionable insight associated with the segment of the population. The actionable insight can correspond to a particular marketing campaign, for example. The actionable insight can include, for example, drafting an email template, generating a recommended digital advertisement, recommendation for a creative refresh, a channel shift, an offer adjustment, segment-specific production recommendations and/or messaging, indication of high- and low-converting segments, automated reporting and stakeholder recommendations, and so on. The processing logic can provide the actionable insight to the user device. In some embodiments, the user device can display the actionable insight, e.g., on a UI of the user device. In some embodiments, the processing logic can automatically perform an action based on an output of the interactive digital persona. For example, the processing logic can flag a segment as a high-potential target or low-potential target for a future marketing campaign. The output of the interactive digital persona can be an output provided in response to a prompt or query provided by a user of the user device.

In some embodiments, processing logic can determine, based on an output of the interactive digital persona, an adjustment to a targeting parameter of a marketing campaign. The targeting parameter can be associated with the segment. The targeting parameter can include, for example, budget allocation, frequency of certain campaign messages, pausing underperforming advertisements, etc. for a particular segment. For example, processing logic can determine that a persona responds more favorably to an advertisement featuring specific imagery or messaging, and can recommend reallocating budget to those creatives for that segment, and/or increasing their frequency for that relevant segment (and/or optionally for other similar segments, e.g., other segments that share similar key features). As another example, processing logic can determine that a persona shows low engagement or conversion rates for a particular advertisement, and can recommend pausing the low-performing advertisement for that segment (and/or optionally for other similar segments). In some embodiments, processing logic can automatically implement the adjustment to the targeting parameter. In some embodiments, processing logic can provide the adjustment to the targeting parameter to the user device. In some embodiments, the user device can display the adjustment to the targeting parameter, e.g., on a UI of the user device.

FIG. 3 depicts a flow diagram of a method 300 for training and using an AI model to represent a persona representing a segment of a population, in accordance with one or more aspects of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 may be performed by the persona module 111 of FIG. 1 to generate one or more interactive, AI-powered persona that represents a consumer segment. In some embodiments, the method 300 may be performed by the summary component 114 of the persona module 111 FIG. 1. In some embodiments, the method 300 may be executed by one or more processing devices of the server 112, to be presented to client devices 120A-120Z.

For simplicity of explanation, the method 300 of this disclosure is depicted and described as a series of acts. However, acts in accordance with this disclosure can occur in various orders and/or concurrently, and with other acts not presented and described herein. Furthermore, not all illustrated acts may be required to implement the method 300 in accordance with the disclosed subject matter. In addition, those skilled in the art will understand and appreciate that the method 300 could alternatively be represented as a series of interrelated states via a state diagram or events. Additionally, it should be appreciated that the method 300 disclosed in this specification are capable of being stored on an article of manufacture (e.g., a computer program accessible from any computer-readable device or storage media) to facilitate transporting and transferring such method to computing devices.

At block 310, the processing logic identifies or receives data points relevant to a particular segment profile of a population. In some embodiments, the data points can be identified from one or more reports, e.g., from survey data representing consumer demographics, behavioral, and/or campaign performance data. The reports can provide foundational variables, such as age, income, lifestyle, and/or purchase behaviors, that define each segment. The data points can correspond to characteristic data 141 of data store 140 of FIG. 1. For example, the data points can reflect demographic, psychographic, behavioral, and/or attitudinal information about the particular segment (e.g., about individuals or groups within a population). The data points can provide foundational variables such as age range, employment status, home ownership or rental status, social media engagement habits, car preferences, online shopping habits, net worth, and/or notable lifestyle or engagement patterns. In some embodiments, the data points can reflect additional demographic details, lifestyle indicators, product and/or brand affinities, and/or other distinguishable features that define the segment's profile.

At block 312, the processing logic identifies segment performance data for a campaign. The segment performance data can correspond to the incidence data 142, index data 143, experience data 144, and/or context data 145 of data store 140 of FIG. 1. In some embodiments, the data points can include segment performance data, reflecting how the population segment performs in relation to specific campaigns or actions. In some embodiments, at block 312, processing logic can retrieve performance data for a specific campaign, which can include conversion rates, impression indices, and/or other key indicators of segment engagement and effectiveness.

At block 314, the processing logic trains the AI model. Training the AI model can include performing blocks 316-320 in some embodiments. At block 316, the processing logic can identify the top and bottom performing population segments for training data. That is, the performance of the population segments can be based on a number of values, such as a corresponding incidence value and/or index value, a conversation rate, an impression rate, a ratio of conversions to impressions, an incremental impact index (e.g., an incremental response rate), etc. The basis for the performance measurement can be predetermined, e.g., according to specific goal. For example, to provide information regarding which segment(s), or which portion(s) of segments, the campaign reached, the performance measurement can be based on the impression index; to provide information regarding which segments (or portion(s) of segments) performed a conversion action, the performance measurement can be based on the conversion index; to provide information regarding which segments (or portion(s) of segments) are most influenced by the campaign, the performance measurement can be based on the incremental impact index; to provide information regarding which segments (or portion(s) of segments) responded to a first campaign compared to which segments (or portion(s) of segments) responded to a second campaign, the performance measurement can be based on the index of the first campaign compared to the index of the second campaign. The performance measurement can be based on additional values, and/or based on a combination of values. The processing logic can identify the top x % performing population segments and/or the bottom x % performing population segments, where x is greater than zero. In some embodiments, the processing logic can compare and contrast the top 10% performing population segments and the bottom 10% performing population segments. Note that the in some embodiments, the processing logic can identify the top x % performing population segments and the bottom y % performing population segments, where x does not equal y. At block 318, the processing logic can train a logistic regression model to find patterns in the training data. At block 320, the processing logic retrieves model coefficients for all data points. Data points can refer to the segments, including the key characteristics within the segments that most differentiate the top performing segments (e.g., the top indexed segments, or portions of segments) to the bottom performing segments (e.g., the bottom indexed segments, or portions of segments).

At block 322, the processing logic takes the top and bottom data points according to the model coefficients (e.g., based on the model weights, or the log regression coefficients). At block 324, the processing logic assigns taxonomy for each data point. Taxonomy can refer to a structured classification scheme used to organize and categorize various components or concepts within the model. For example, processing logic can assign each data point to a category (sometimes referred to a class). Examples of taxonomy can include alcohol, apparel and jewelry, automotive, etc. At block 326, the processing logic retrieves top and bottom data points for each category in the taxonomy. That is, the processing logic can retrieve the outliers for each category, and disregard the rest. For example, the processing logic can retrieve the top 5 performers and the bottom 5 performers from each category. At block 328, the processing logic sorts the results. For example, the processing logic can identify the top 20 performing categories and the bottom 20 performing categories. As another example, the processing logic can identify the top 10% performing classes and the bottom 10% performing classes. Blocks 322-328 can help provide equal chance to all classes by considering all categories, rather than considering only the category or categories with the heaviest weight(s).

At block 330, the processing logic constructs messages to serve as a summary prompt, e.g., for summary component 114. The processing logic can construct a message for each segment persona. In some embodiments, the processing logic can construct JavaScript Object Notation (JSON) messages. Each message can encapsulate the key characteristics and performance metrics of a particular segment. The constructed message can serve as the input for prompt engineering, where an LLM is prompted to process and summarize the data.

At block 340, the processing logic constructs a prompt to process the JSON message for a particular segment persona. The prompt can be constructed so that the LLM's responses are grounded in the actual data, leveraging RAG techniques to supplement the model's general knowledge with segment-specific data. The processing logic can provide the prompt to a trained AI model. The prompt can instruct the trained AI model to use the JSON messages in a RAG approach. At block 342, the processing logic outputs a summary for a segment (e.g., as described with respect to FIG. 7). In some embodiments, the processing logic can employ a RAG architecture using a foundational LLM, which can identify patterns or generated responses without requiring a separate logistic regression step. As an illustrative example, aspects of the present disclosure can employ a RAG approach using a foundational large language model, using the indexes and instructions to compare and contract the top performing and bottom performing profile descriptions, to produce an output.

Method 300 can be iterative, allowing for continuous refinement of personas as new data becomes available or as additional questions are posed. A user can interact with the personas (e.g., by asking questions and receiving responses that are consistent with the underlying data) enabling a conversational exploration of consumer motivations, preferences, and/or behaviors.

FIG. 4 depicts a flow diagram of a method 400 for identifying and providing additional data to a trained AI model representing a segment persona, in accordance with one or more aspects of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 may be performed by the persona module 111 of FIG. 1 to construct an AI-generated persona that accurately reflects the characteristics and behaviors of a consumer segment. In some embodiments, the method 400 may be performed by the persona component 115 of the persona module 111 of FIG. 1. In some embodiments, the method 400 may be executed by one or more processing devices of the server 112, to be presented to client devices 120A-120Z.

For simplicity of explanation, the method 400 of this disclosure is depicted and described as a series of acts. However, acts in accordance with this disclosure can occur in various orders and/or concurrently, and with other acts not presented and described herein. Furthermore, not all illustrated acts may be required to implement the method 400 in accordance with the disclosed subject matter. In addition, those skilled in the art will understand and appreciate that the method 400 could alternatively be represented as a series of interrelated states via a state diagram or events. Additionally, it should be appreciated that the method 400 disclosed in this specification are capable of being stored on an article of manufacture (e.g., a computer program accessible from any computer-readable device or storage media) to facilitate transporting and transferring such method to computing devices.

At block 410, the processing logic identifies or receives data points from one or multiple reports. For example, the processing logic can identify data points relevant to a particular segment profile of a population. In some embodiments, processing logic can receive one or more reports, and can identify the relevant data points from the report(s). The report(s) can contain a wide array of variables and characteristics associated with different consumer segments, such as demographic information, lifestyle preferences, purchasing behaviors, and so on. The reports can include, for example, a survey, a segment report, marketing performance report, and so on. The data points can correspond to characteristic data 141, the incidence data 142, index data 143, experience data 144, and/or context data 145 of data store 140 of FIG. 1.

At block 412, the processing logic fetches the most significant segment characteristics from each report. Fetching the most significant segment characteristics can include performing blocks 414-418. At block 414, the processing logic can identify one or more key indicator for each characteristic. The key indicator can be an incidence value (e.g., a measure of frequency of occurrence, e.g., measured as users/100 households), and/or an index value. That is, the characteristics in a report can each be accompanied by one or more key indicators, such as an incidence value (e.g., the number of users per 100 households), an index value (e.g., a measure of how much more or less likely the characteristic is to occur in the segment compared to the general population), and/or other key indicators, and the processing logic can identify the one or more key indicators for each characteristic.

At block 416, the processing logic identifies the top performing characteristics (e.g., the top 10, or the top 10%) based on the identified key indicators. The top performing characteristics are merged to form a consolidated set of the most defining characteristics (or attributes) for the segment. By merging the results, The processing logic can provide the consolidated set(s) of the most defining characteristics to the foundational LLM to find commonality and create a single over-arching segment by finding the top characteristics the segments have in common that also differentiate it from the bottom performing segments.

At block 418, the processing logic creates a characteristics list that includes the top characteristics identified at block 416. In some embodiments, the characteristics list can be a data structure that includes the top characteristics of a segment, and the incidences and indexes corresponding to each segment. The characteristics list can serve as a structured, data-rich summary of the segment, capturing both the prevalence and distinctiveness of each characteristic.

At block 440, the processing logic constructs a prompt to process the characteristics list. The processing logic can construct the prompt for the fine-tuned trained AI model representing the segment. The prompt can be designed to condition the AI model's responses on the specific data provided so that the generated persona remains consistent with the underlying segment data. The prompt can enable the trained AI model to use the characteristics list in a RAG approach. That is, the characteristics list can be used as external data in a RAG workflow. When a user interacts with the persona generated by the AI model, the AI model can reference the characteristics list to retrieve relevant facts and context so that the answers are statistically representative of the segment. For example, if a segment is characterized by a high index for luxury car ownership, the persona generated by the AI model will consistently reflect this trat in its responses. The processing logic can prompt the AI model to use the characteristics list as the basis for all persona responses, so that even when asked about topics not explicitly covered in the list, the AI model can infer answers that are consistent with the segment's overall profile, reducing the risk of the persona deviating from the data or providing contradictory information. Because the characteristics list encapsulates the defining features of the segment, it can act as a persistent reference throughout the conversation. Additionally, the inclusion of the incidence and index values in the characteristics list can enable transparent validation of persona responses. For example, if a user queries the persona about a specific behavior or preference, the AI model's answer can be tracked back to the corresponding metric in the characteristics list, allowing for an explanation of why the persona responded in that particular way. The characteristics can be dynamically updated or supplemented with additional context or experience data, e.g., as the data becomes available. This can enable the persona to adapt its responses to reflect not only static segment traits but also recent behaviors or contextual nuances, while still remaining anchored in to the chore segment data.

At block 442, the processing logic enables a conversation to begin between a user and the trained AI model. The AI model, primed with the characteristics list, can respond to user queries as if it were a member of the target segment, providing answers that are both data-driven and contextually relevant. An example of the conversion is described with respect to FIG. 7.

FIGS. 5A-B depict a flow diagram of methods 500, 550 for identifying and providing additional data to a trained AI model to enhance the AI-driven segment persona, in accordance with one or more aspects of the present disclosure. The methods 500, 550 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the methods 500, 550 may be performed by the persona module 111 of FIG. 1 to construct an AI-generated persona that reflects the characteristics and behaviors of a segment. In some embodiments, the method 400 may be performed by the persona plus component 116 of the persona module 111 of FIG. 1. In some embodiments, the methods 500, 550 may be executed by one or more processing devices of the server 112, to be presented to client devices 120A-120Z.

For simplicity of explanation, the methods 500, 550 of this disclosure is depicted and described as a series of acts. However, acts in accordance with this disclosure can occur in various orders and/or concurrently, and with other acts not presented and described herein. Furthermore, not all illustrated acts may be required to implement the methods 500, 550 in accordance with the disclosed subject matter. In addition, those skilled in the art will understand and appreciate that the methods 500, 550 could alternatively be represented as a series of interrelated states via a state diagram or events. Additionally, it should be appreciated that the methods 500, 550 disclosed in this specification are capable of being stored on an article of manufacture (e.g., a computer program accessible from any computer-readable device or storage media) to facilitate transporting and transferring such method to computing devices.

At block 510, the processing logic collects campaign common information. Campaign common information can be a collection of shared parameters and/or metadata that apply across different individual campaigns. The parameters and/or metadata can include, for example, campaign name, objective, start/end dates, audience type, channel, and so on. Collecting campaign common information can include performing blocks 512-514. At block 512, the processing logic retrieves campaign taxonomy. The campaign taxonomy can include the category assigned to each data point in the campaign. At block 514, the processing logic retrieves the campaign name. In some embodiments, the campaign common information can correspond to context data 145 of FIG. 1.

At block 516, the processing logic collects campaign performance information. In some embodiments, the campaign performance information can correspond to experience data 144. In some embodiments, the campaign performance data can include metrics such as conversions, impressions, and/or segment-specific engagement rates, for example. In some embodiments, collecting campaign performance information can include performing blocks 518-520. At block 518, the processing logic can identify performance data of the top and bottom segments. For example, the processing logic can identify the performance of the top 4 and bottom 4 segments. In some embodiments, the processing logic can identify the performance of the top 10% and the bottom 10% segments. The segments can be ranked based on conversions, incidence, index, and/or incrementality (e.g., conversions caused by the content item), and the processing logic can identify the top ranking segments based on the ranking. At block 520, the processing logic can identify the performance of a target persona's segment, e.g., as identified by a user of a client device 120A-Z. The target persona's segment can be generated by persona plus component 116.

At block 522, the processing logic collects data points from reports. The reports can include specifics about which content items were provided when, what was included in each content item, how the content item was provided (e.g., on what kind of medium, via what channel, etc.), and the results of the content item (e.g., the conversions, the incidence, the index, and/or other performance measurements). The processing logic can identify data points relevant to a particular segment profile of a population. In some embodiments, the data points can be identified from a report, e.g., from survey data. Examples of data points include the number of content items that were provided per week for a campaign, the number of content items that were provided during a particular time of the day, the number of content items that were provided during a particular day of the week, the number of content items that were provided via a first channel as compared to another channel, the number of content items provided using a first message compared to the number of content items provided using a second message, etc. The data points can reflect which types of personas were influenced by which campaign and/or content items, how different personas may have been influenced by different combinations of messages in difference contexts (context refers to the time of day, day or week, and the method/channel of delivery), etc. Based on various reports, the processing logic can identify meta-patterns across the data points.

At block 524, the processing logic identifies the most significant segment characteristics from the top segment(s) and/or bottom segment(s), and/or target persona segments from all reports, for each data point, e.g., by performing blocks 526-530. The most significant characteristics can refer to the characteristics that the top performers (e.g., top performing segments) have in common that also differentiate the top performers from the bottom performers. At block 526, the processing logic can identify one or more indicator for each characteristic, such as incidence (e.g., a measure of the frequency of occurrence, e.g., measured as users/100 households), and/or the index. At block 528, the processing logic takes the top performers (e.g., the top indicator values) and merges the results. In some embodiments, the processing logic can use a clustering algorithm to product a measure of statistical significance in the difference between the top and bottom performers. In some embodiments, the processing logic can use a foundational LLM to summarize the most significant differences based on its interference from the data. At block 530, the processing logic takes the top characteristics for each type of persona's segment (e.g., the top 2 characteristics). In some embodiments, the processing logic can use a foundational LLM to narrow down the characteristics to the most differentiating characteristics, to provide a human-understandable summary of the characteristics. As an illustrative example, the foundational LLM used to narrow the characteristics to the most differentiating characteristics can provide the following output: “Given its appeal and setup, the site may resonate more strongly with the top converting segments-rural and possibly traditional values-driven demographics-due to its straightforward, easily accessible gaming style, reminiscent of classic games which might be familiar and nostalgic. On the other hand, the lower converting segments, which include urban, affluent, and cosmopolitan individuals, may find the site's offerings less engaging due to their possibly sophisticated tastes and preferences for more diverse, upscale, or advanced experiences. This could explain why segments such as ‘Urban Elders’ and ‘Movers and Shakers’ convert at lower rates, as they might seek more varied and technologically advanced entertainment options.” The key characteristics described as “rural and possibly traditional values-driven demographics” is the way the LLM summarized the top converting segments, while the key characteristics described as “urban, affluent, and cosmopolitan individuals” is the way the LLM summarized the bottom converting segments.

At block 532, the processing logic creates contextual characteristic lists, e.g., corresponding to contextual characteristic list 147 of FIG. 1. The contextual characteristic list can highlight the most differentiating features for each persona segment so that the AI model can be grounded in the most relevant and impactful data.

The method proceeds to FIG. 5B, method 550. At block 560, the processing logic constructs a prompt 570 to process and analyze collected data. The prompt can enable the trained AI model to use the collected data in a RAG approach. As an illustrative example, after assembling the data for a persona and assigning a name to the persona, the processing logic can construct the following prompt to a foundational LLM: “You are a persona AI. Your role is to assume the personality of the segment known as [insert persona name]. Consider all the variables for the segment and tell me your name, what you are wearing, and a bit of about yourself.” The processing logic provides the prompt to the foundational LLM, along with the collected data. The prompt can invoke a persona within the context window of an LLM.

At block 562, the processing logic receives an analysis result. That is, the processing logic receives an output 572 from the LLM in response to the provided prompt. At block 564, the processing logic generates a cached generic persona. That is, once in the context window, the processing logic generates a cached persona. The cached generic persona can be based on the summary and/or characteristics list (e.g., characteristic list 146 of FIG. 1). At block 566, the processing logic adjusts the cached generic persona to the analysis performed. For example, generic cached persona can be adjusted with campaign-specific analysis to reflect the context and/or experience data relevant to the segment. In some embodiments, the processing logic can adjust the cached generic persona using the contextual characteristic list (e.g., contextual characteristic list 147 of FIG. 1). This adjustment enables the persona's responses and behaviors to be not only consistent with the underlying demographic and psychographic data but are also to be conditioned by recent actions or exposures, such as visiting a particular website or responding to a specific ad campaign. The processing logic can create custom instructions (e.g., prompt 574) to remind the LLM to refer to the collected data and analysis (using the RAG method) so that the answers provided by the LLM remain consistent with the details of the persona. At block 568, the processing logic enables a conversation to begin between a user and the trained AI model, e.g., via prompt 576. Thus, at block 568, a dynamic, conversational interaction is enabled between the user and the AI-drive persona, during which the persona can provide insights and explanations that are both data-driven and contextually aware, allowing the user to “talk to their data” and explore how different segments might react to various campaign scenarios. An example of the conversion is described with respect to FIG. 9.

FIG. 6 illustrates an example input data table 600, in accordance with one or more aspects of the present disclosure. In some embodiments, the data table 600 can be stored in data store 140 of FIG. 1. In some embodiments, persona module 111 of FIG. 1 can provide the input data table 600 to a trained AI model, e.g., as described with respect to persona module 111. The input data table 600 can serve as a foundational element in the process of generating AI-driven personas for user behavior profiling. In some embodiments, the persona module 111 can provide the input data table 600 to a trained AI model as part of a RAG approach, allowing the AI model to ground persona narratives, responses, and/or simulated behaviors in real, quantifiable data. As illustrated in FIG. 6, the input data table 600 can include a title 602 of the characteristic variable, which names and/or describes the characteristic being measured (e.g., “Home Internet for personal use: A); a category 604 of the characteristic variable, which classified the characteristic into a broader domain (e.g., “Office Tech”); a incidence value 606 of the characteristic variable, which quantifies the percentage of the segment population exhibiting the characteristic (e.g., “37.13%”); and/or a index 608 of the characteristic variable, which provides a normalized measure indicating how much more likely or less likely the characteristic is to occur in the segment compared to the general population (e.g., “99.093).

The persona module 111 can use the input data table 600 to condition the AI model with both the prevalence (e.g., incidence) and distinctiveness (e.g., index) of various characteristics within a segment. The conditioned AI model can then generate a persona (or personas) that is statistically accurately and contextually relevant. Including both the index and the incidence can enable the conditioned AI model to differentiate traits that are unique or defining for a segment from those that are merely common across the general population.

The input data table 600 can encompass a wide range of characteristics, such as technology use, lifestyle choices, shopping habits, etc., each categorized and quantified for precise persona generation. Other example entries might include “has Internet connected home device,” “Watch video content on tablet,” “has mobile phone number,” “did not switch mobile phone provider in past year,” and so on.

FIG. 7 illustrates an example UI 700 displaying a conversation with a persona provided by the trained AI model, in accordance with one or more aspects of the present disclosure. UI 700 demonstrates the conversational capabilities of a trained AI model that represents a segment-based persona. As illustrated in FIG. 7, the UI 700 can include a summary section 702 and a conversation section 704. In some embodiments, the summary section 702 can be generated and/or provided by summary component 114 of FIG. 1. In some embodiments, the conversation section 704 can be provided by persona component 115 or persona plus component 116.

The summary section 702 can provide a concise narrative overview of the persona, synthesizing key demographic and/or behavioral characteristics that define the segment. That is, the summary section 702 can provide a narrative that represents a concatenation of some of the key data points that are distinctive for the segment. For instance, as illustrated in FIG. 7, the summary 702 might describe a young adult named Anthony, aged 28, living with roommates in a rented home, working full-time, considering returning to school, and who enjoys gaming, online shopping, an listening to music. This narrative is constructed from underlying segment data, including age, living situation, shopping preferences, and/or lifestyle habits, to create a relatable and realistic persona profile. For example, the narrative can be constructed by the summary component 114 using characteristic data 141 of FIG. 1.

The conversation section 704 of the UI allows a user (e.g., of a user device 102A-Z) to interact directly with the persona through natural language prompts, enabling a dynamic exchange where the AI-generated persona responds in character, grounded in the segment's data. The conversation section 704 of the UI can bring the AI-generated persona to life and allow users to explore the attitudes, preferences, and likely behaviors of the segment in a highly accessible and engaging manner.

In some embodiments, UI 700 can be displayed as an introduction to the interactive digital persona. A user can interact with the persona by clicking on the “Continue the conversation” button 706 in the UI. By selecting the “Continue the conversation” button 706, the UI can transition from displaying the persona's summary to enabling an interactive, real-time dialogue with the AI-generated persona. For example, the user can input questions or prompts to the persona, and the AI-generated persona can respond in character, drawing on the detailed segment data, including demographic, behavioral, and/or contextual information that defines the segment. An example UI displaying a conversation is described with respect to FIG. 8.

FIG. 8 illustrates an example UI components 804, 806 illustrating the interactive conversational capabilities of a persona provided by the trained AI model, in accordance with one or more aspects of the present disclosure. In some embodiments, UI component 804 and/or UI component 806 can be provided by persona module 111. In some embodiments, UI component 804 and/or UI component 806 can be provided for display via UI 124A-Z of client device 120A-Z. UI component 804 illustrates a textual prompt, e.g., as received from user input. UI component 806 illustrates the textual prompt followed by the textual output provided by the trained AI model. FIG. 8 illustrates how a user can interact with the data by using the conversational capabilities of the trained AI model. That is, FIG. 8 illustrates how a user can engage in a dialogue with a data-driven persona whose responses are grounded in segment-specific data. The output of the trained AI model, illustrated in UI component 806, is conditioned on the data provided via the persona overall description, the incidence and index table(s), and/or additional data corresponding to the persona.

As illustrated in FIG. 8, a user (e.g., of a user device 120A-Z) can provide a textual interaction via UI component 804. The interaction includes the question “Do you use a connected home device?” The textual interaction can be submitted to the AI-driven persona. The AI-driven persona can provide the following response “Yes, I use a smartphone extensively, which means I'm pretty comfortable with technology. Connected home devices fit well into my digital-focused lifestyle. I'm all about streaming my favorite playlists on my favorite platform, and using a connected home device just makes things more convenient. It's handy for setting reminders or catching up on the news, especially when I'm busy with gaming or browsing through the latest apps.” In some embodiments, the persona module 111 can send the AI-driven persona's response to the client device 120A-Z (e.g., the client device 120A-Z from which the user interaction was received), and the client device 120A-Z can output the response (e.g., via UI 124A-Z). The interaction illustrated in FIG. 8 exemplifies how a user can interact with (e.g., converse with or talk to) the data, enabling a dynamic, interactive experience where every response from a persona is anchored in real-world segment data (and optionally campaign context).

In some embodiments, the user can provide an interaction (e.g., ask a question) on a topic that is not included in the persona's data (e.g., not explicitly included in data 141-147 of FIG. 1). For example, in the example illustrated in FIG. 8, the AI-driven persona may not have been trained on data corresponding to connected home devices. The AI-driven persona can leverage the persona's segment data to infer an answer that is reasonable given all the other data that is available for the persona.

FIG. 9 illustrates an example UI 900 displaying an output of a trained AI model (e.g., of a particular persona provided by the trained AI model) based on experience and/or context of a segment, in accordance with one or more aspects of the present disclosure. In some embodiments, the UI 900 can be provided by persona module 111. In some embodiments, UI 900 can be provided for display via UI 124A-Z of client device 120A-Z. The UI 900 can display the index of multiple segments, as illustrated by graph 901. Graph 901 can represent the relative likelihood of different segments to engage in a particular behavior, action, or conversion, e.g., purchasing a product or visiting a website. The UI 900 provides a user with the option to explore “leading personas” (e.g., those segments most likely to perform the behavior, action, or conversion) and “leading personas plus,” which are those personas further conditioned on contextual or experience data, such as having completed the specific conversion or having been exposed to a particular campaign.

As an illustrative example, the leading personas plus can be contextualized by supplementing the persona's foundational demographic and behavioral data with additional variables, such as the specific website visited, the ad that led to the conversion, or the campaign context. For example, if the persona is being used to analyze baseball ticket purchases, the system can condition the persona on having visited the team's website or having responded to a particular ad, and it can contrast the top and bottom converting segments to provide deeper insights.

The UI 900 includes a dropdown menu allowing a user to select a particular segment. As illustrated in FIG. 9, the selected segment is “Segment W,” which represents 1.41% of US households. The UI 900 includes an “about me” section that provides a high-level description of a representative member of the segment. In some embodiments, the bullet points in the “about me” section can reflect the characteristic data of the segment (e.g., characteristic data 141 of FIG. 1). The UI 900 can also include a summary section that provides a narrative overview of the persona. In some embodiments, the “about me” section and the narrative overview can correspond to sections 702 and 704 of FIG. 7. In some embodiments, UI 900 can be provided by, or supported by, the persona component 115 and/or the persona plus component 116 of FIG. 1.

The UI 900 can enable a user to start a “virtual focus group” (e.g., as described with respect to FIG. 10), to explore all personas (e.g., as described with respect to FIG. 11), and/or to interact with an avatar representation of a segment persona (e.g., as described with respect to FIG. 13). A virtual focus group can enable a user to interact with multiple personas side-by-side, each representing a different segment, and see how their responses differ when grounded in both general and context-specific data.

FIGS. 10A-B illustrates example UIs 1010, 1020 displaying outputs of multiple trained AI models, each AI model representing a distinct segment and providing a distinct persona, in accordance with one or more aspects of the present disclosure. In some embodiments, UI 1010 and/or UI 1020 can be provided by persona module 111. In some embodiments, UI 1010 and/or UI 1020 can be provided for display via UI 124A-Z of client device 120A-Z. Example UIs 1010, 1020 can be used as virtual focus groups, to compare and contrast various segment personas side by side. Example UIs 1010, 1020 display five personas, however fewer or additional personas can be displayed. A user (e.g., of client device 120A-Z) can interact with all personas at once. For example, a user can input a prompt (e.g., via a UI 124A-Z), which can then be processed by the trained AI model corresponding to each segment. The output of each trained AI model can be displayed in a portion of the UI 1010, 1020 corresponding to the respective persona. In some embodiments, the persona module 111 can provide the prompt to the corresponding trained AI model(s), and the persona module 111 can send the output of the trained AI model(s) to the corresponding client device 120A-Z (e.g., the client device 120A-Z from which the user input was received). The corresponding client device 120A-Z can provide the output for display on the client device 120A-Z, e.g., via UI 124A-Z.

As an illustrative example, the prompt in UI 1010 includes the question “Do you like baseball?” A response from each of the trained AI models is displayed corresponding to the respective persona. The prompt in UI 1020 includes the question “What type of people do you think you would not like baseball?” A response from each of the trained AI models is displayed corresponding to the respective persona.

The UI 1010 and 1020 can include multiple UI portions (e.g., multiple dedicated panels), each one corresponding to a particular persona. Each UI portion can include the persona name, a name of the representative member of the segment, the percentage of US households that belong to the segment, an “about me” option, and a response to the query. Each UI portion can also include a toggle (or switch) that enables a user to select or deselect a particular persona from participating in the virtual focus group. For example, in UI 1020 of FIG. 10B, the toggle for persona 4 has been switched, and thus persona 4 has not provided an answer to the query. In some embodiments, a user can interact with (e.g., click on or hover over) the “about me” option to display an “about me” overview of the segment (e.g., as described with respect to FIGS. 7 and 9).

The virtual focus groups illustrated in FIGS. 10A-B enables users to quickly discern differences and similarities in attitude, preferences, and/or motivations across segments. for example, one persona may express enthusiasm for baseball based on tradition an family, while another may indicate a preference for faster-paced sports, reflecting the nuanced distinctions between segments. In some embodiments, UIs 1010 and 1020 can be provided by, or supported by, the multiple persona component 117 of FIG. 1.

FIG. 11 illustrates an example UI 1100 displaying a comparative analysis of multiple trained AI models, each one representing a distinct segment and providing a distinct persona, in accordance with one or more aspects of the present disclosure. In some embodiments, UI 1100 can be provided by persona module 111. In some embodiments, UI 1100 can be provided for display via UI 124A-Z of client device 120A-Z. In some embodiments, the persona module 111 (e.g., the aggregated personas component 118) can receive an input from a UI, in which a user has inputted a query or prompt. The user can be a user of a client device 120A-Z of FIG. 1, and the UI can correspond to UI 124A-Z. In the illustrative example of FIG. 11, the input provided via the UI can be “Which segments are most likely to buy this vehicle?” The aggregated personas component 118 can provide the input to multiple AI-driven personas, and receive outputs for each persona. The aggregated personas component 118 can synthesize and analyze the output of each persona. For example, the aggregated personas component 118 can rank and contrast the likelihood of different segments to engage in a specific behavior (e.g., corresponding to the user's input), such as making a purchase. As illustrated in FIG. 11, the UI 1100 can list the top segments most likely to convert, accompanied by a tailored sales pitch and/or explanation that resonates with the unique preferences and lifestyles of each segment. For example, the aggregated personas component 118 can generate distinct messaging for a luxury-oriented segment versus a value-driven one, reflecting the nuanced motivations and barriers reflected in the underlying data. this approach allows marketers to see not only which segments are statistically more likely to respond positively, but also why, e.g., by providing narrative context and rationale for each recommendation. That is, the persona module 111 can contrast high and low converting segments, offering insights in what differentiates them, such as lifestyle, values, or previous engagement patterns. In some embodiments, the persona module 111 can provide the output of the aggregated personas component 118 to the corresponding client device 120A-Z (e.g., the client device 120A-Z from which the user input was received). The corresponding client device 120A-Z can provide the output for display on the client device 120A-Z, e.g., via UI 124A-Z.

FIG. 12 illustrates an example input data table 1200 of conversion rates for various segments, in accordance with one or more aspects of the present disclosure. In some embodiments, input data table 1200 can be stored in data store 140 of FIG. 1. In some embodiments, the data table 1200 can include the segment label 1202, and the corresponding impression index 1204, index of conversions 1206, and/or conversion to impression ratio 1208 for each segment. An impression can be described as a metric that indicates the number of times a content item is displayed to a user. For example, an impression is each time a content item is loaded on a webpage or app, regardless of whether the user actually interacts with it. The impression index represents a measure of how frequently a content item is displayed to a specific target audience segment compared to its display frequency across the entire population. In other words, it can measure of how much more likely a content item is shown to a targeted segment relative to the overall population. A conversion can refer to the completion of a desired action by a user in response to being provided with a content item. The desired action can be, for example, making a purchase, visiting a particular website, clicking on a link, filling out a form, registering for an event, downloading an app, engaging with content, etc. The index of conversions represents a measure of the percentage of times a specific action occurs within the target audience segment, divided by the percentage of times the specific action occurs in the entire population. The index of conversions can provide insight into how much more likely a targeted segment is to take the desired action compared to the overall population. The conversion to impression ratio can represent the effectiveness of a content item in terms of converting viewers into active participants who take the desired action. The conversion to impression ratio can be calculated by dividing the number of conversions achieved by the total number of impressions delivered. The conversion to impression metric can help assess how effective a campaign is in terms of converting viewers into active participants who take the desired action. A higher conversion to impression ratio can indicate that a larger percentage of people who viewed a content item took the desired action.

Thus, each row in the input data table 1200 can represent a distinct segment, providing quantitative measures of how frequently a content item (e.g., an advertisement or campaign message) is displayed to that segment (e.g., impression index 1201), how often members of the segment complete a desired action (e.g., index of conversion 1206), and/or the efficiency of those impressions in driving conversions (E.g., conversion-to-impression ratio 1208). The input data table 1200 can reflect real behavioral outcomes, updated during an ongoing campaign (e.g., every hour, once a day, upon a triggering event, etc.).

In some embodiments, the persona module 111 can rank the segments in data table 1200, e.g., by order of highest and lowest conversions. By ranking the segments according to these metrics, the persona module 111 can identify which groups are most and least responsive to specific campaigns or products. The impression module 111 (e.g., the persona plus component 116, the multiple persona component 117, and/or the aggregated personas component 118) can provide the input data table 1200 to the trained AI model, e.g., as part of a RAG approach. The trained AI model can use the input data table 1200 to contrast the top and bottom converting segments, and/or to derive explanations for why some segments converted at higher versus lower rates. For example, a segment with a high conversion-to-impression ratio may be more receptive to a particular marketing message, while another with a low ratio may more receptive to a different approach.

FIG. 13 illustrates an example of an avatar 1300 representing a segment of a population, in accordance with one or more aspects of the present disclosure. In some embodiments, persona module 111 (e.g., avatar component 113) can generate a visual representation 1300 of a segment persona. The avatar component 113 can animate the visual representation 1300, and display the visual representation 1300 in a UI of a user device. The avatar component 113 can enable a user to interact with the visual representation 1300, via text and/or audio. That is, a user of a user device (e.g., client device 120A-Z of FIG. 1) can type an interaction in the UI or can interact with the visual representation through speech (e.g., via an audio-based interaction). The avatar component 113 record the audio of an audio-based interaction, and/or can convert an audio-based interaction into text. The avatar component 113 can provide the text interaction to the trained AI model representing the segment, and can receive an output of the trained AI model. The avatar component 113 can provide the textual output of the trained AI model in the UI of the user device (e.g., to the client device 120A-Z from which the input was received), and/or can convert the textual output to audio. The avatar component 113 can animate the visual representation 1300 of the segment persona to appear as though the visual representation 1300 is saying the words of the converted output, e.g., by generating a video stream that visually represents the persona as it speaks and/or reacts during the conversation. The avatar component 113 can provide the video stream and/or the audio stream of the persona's audio-based response to the corresponding user device (e.g., client device 120A-Z). The corresponding client device 120A-Z can output the video stream and/or the audio stream, e.g., via UI 124A-Z. For example, a user can ask the avatar questions about preferences, motivations, and/or behaviors, and the avatar will response in a manner that reflects the segment's profile, as defined by the survey data, incidence and index metrics, and/or additional data. The avatar can be used individually or as part of a virtual focus group, allowing marketers and creatives to explores nuanced consumer insights, test messaging, and brainstorm strategies in a dynamic, conversational environment.

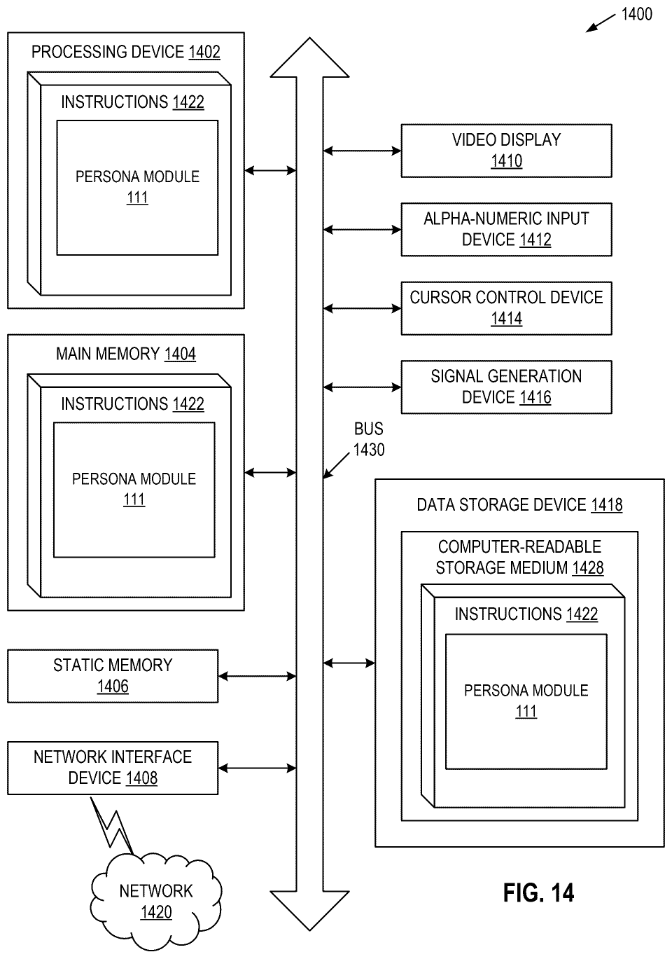

FIG. 14 depicts a block diagram of an example computing system 1400 operating in accordance with one or more aspects of the present disclosure. In various illustrative examples, computer system 1400 may correspond to any of the computing devices within system architecture 100 of FIG. 1. In one implementation, the computer system 1400 may be the server device 112.

In certain implementations, computer system 1400 may be connected (e.g., via a network, such as a Local Area Network (LAN), an intranet, an extranet, or the Internet) to other computer systems. Computer system 1400 may operate in the capacity of a server or a client computer in a client-server environment, or as a peer computer in a peer-to-peer or distributed network environment. Computer system 1400 may be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 1400 may include a processing device 1402, a volatile memory 1404 (e.g., random access memory (RAM)), a non-volatile memory 1406 (e.g., read-only memory (ROM) or electrically-erasable programmable ROM (EEPROM)), and a data storage device 1416, which may communicate with each other via a bus 1408.

Processing device 1402 may be provided by one or more processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 1400 may further include a network interface device 1422. Computer system 1400 also may include a video display unit 1410 (e.g., an LCD), an alphanumeric input device 1412 (e.g., a keyboard), a cursor control device 1414 (e.g., a mouse), and a signal generation device 1420.

Data storage device 1416 may include a non-transitory computer-readable storage medium 1424 on which may store instructions 1426 encoding any one or more of the methods or functions described herein, including instructions implementing persona module 111 of FIG. 1 for implementing the methods described herein.

Instructions 1426 may also reside, completely or partially, within volatile memory 1404 and/or within processing device 1402 during execution thereof by computer system 1400, hence, volatile memory 1404 and processing device 1402 may also constitute machine-readable storage media.

While computer-readable storage medium 1424 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

In the foregoing description, numerous details are set forth. It will be apparent, however, to one of ordinary skill in the art having the benefit of this disclosure, that the present disclosure can be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “receiving”, “identifying”, “determining”, “generating”, “assigning”, “inputting”, “selecting”, “training”, “moving”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

For simplicity of explanation, the methods are depicted and described herein as a series of acts. However, acts in accordance with this disclosure can occur in various orders and/or concurrently, and with other acts not presented and described herein. Furthermore, not all illustrated acts can be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

Certain implementations of the present disclosure also relate to an apparatus for performing the operations herein. This apparatus can be constructed for the intended purposes, or it can comprise a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions.

Reference throughout this specification to “one implementation” or “an implementation” means that a particular feature, structure, or characteristic described in connection with the implementation is included in at least one implementation. Thus, the appearances of the phrase “in one implementation” or “in an implementation” in various places throughout this specification are not necessarily all referring to the same implementation. In addition, the term “or” is intended to mean an inclusive “or” rather than an exclusive “or.” Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

What is claimed is:

1. A method comprising:
identifying data associated with a segment of a population, wherein data comprises one or more characteristics of the segment;
generating, based on the data, an interactive digital persona representing the segment; and
causing the interactive digital persona representing the segment to be provided to a user device.

2. The method of claim 1, wherein generating the interactive digital persona comprises:
providing the data to a trained artificial intelligence (AI) model configured to generate the interactive digital persona, wherein the data supplements, using retrieval-augmented generation (RAG), the trained AI model, and wherein the trained AI model generates the interactive digital persona.

3. The method of claim 1, further comprising:
identifying at least one of index data or incidence data associated with the segment; and
providing the at least one of the index data or the incidence data to a trained AI model configured to generate the interactive digital persona, wherein the at least one of the index data or the incidence data supplements, using RAG, the trained AI model, and wherein the trained AI model generates the interactive digital persona.

4. The method of claim 1, further comprising:
identifying additional data associated with at least a subset of the segment, wherein the additional data comprises at least one of context data or experience data, wherein the experience data reflects one or more actions taken by one or more members of the segment, and wherein the context data reflects contextual information of a corresponding action of the one or more actions; and
providing the additional data to a trained AI model, wherein the additional data supplements, using RAG, the trained AI model, and wherein the trained AI model generates the interactive digital persona.

5. The method of claim 1, wherein causing the interactive digital persona representing the segment to be provided to the user device comprises:
providing a graphical user interface (GUI) for display on a user interface (UI) of the user device, wherein the GUI comprises a first portion to receive an interaction of a user of the user device, wherein the GUI comprises a second portion to display a response generated by a trained AI model, wherein the trained AI model generates the interactive digital persona.

6. The method of claim 5, wherein the GUI comprises an avatar representing a member of the segment.

7. The method of claim 1, further comprising:
receiving an interaction of a user of the user device, wherein the interaction is associated with the interactive digital persona, and wherein the interaction comprises at least one of a textual input or a audio input;
providing the interaction of the user as input to a trained AI model, wherein the trained AI model is trained to generate the interactive digital persona;
receiving an output from the trained AI model, wherein the output comprises a response of the interactive digital persona to the interaction of the user; and
providing, for display on a user interface, the output, wherein the output comprises at least one of a textual output or a audio output.

8. The method of claim 1, further comprising:
identifying one or more trained AI models, wherein each of the one or more trained AI models corresponds to a distinct segment of a plurality of segments of the population, wherein the plurality of segments comprises the segment of the population, wherein each of the one or more trained AI models is trained to generate a corresponding interactive digital persona;
receiving an interaction of a user of the user device, wherein the interaction is associated with the interactive digital persona, and wherein the interaction comprises at least one of a textual input or an audio input;
providing the interaction as input to the one or more trained AI models;
receiving one or more outputs from the one or more trained AI models, wherein each of the one or more outputs is received from a corresponding trained AI model of the one or more trained AI models, and wherein each of the one or more trained AI models corresponds to a distinct interactive digital persona; and
providing, for display on a user interface of the user device, the one or more outputs, wherein each of the one or more outputs comprise at least one of a textual output or an audio output.

9. The method of claim 1, wherein the one or more characteristics comprise at least one of: an age range, a employment status, a home ownership status, social media engagement habits, car preference, online shopping habits, net worth, income, or notable engagements.

10. The method of claim 1, further comprising:
generating, based on an output of the interactive digital persona, an actionable insight associated with the segment of the population; and
providing, to the user device, the actionable insight.

11. The method of claim 1, further comprising:
determining, based on an output of the interactive digital persona, an adjustment to a targeting parameter of a marketing campaign, wherein the targeting parameter is associated with the segment of the population; and
automatically applying the adjustment to the targeting parameter of the marketing campaign.

12. A system comprising:
a memory device; and
a processing device operatively coupled to the memory device, the processing device to execute instructions from the memory to:
identify data associated with a segment of a population, wherein data comprises one or more characteristics of the segment;
generate, based on the data, an interactive digital persona representing the segment; and
cause the interactive digital persona representing the segment to be provided to a user device.

13. The system of claim 12, wherein to generate the interactive digital persona, the processing device is further to:
provide the data to a trained artificial intelligence (AI) model configured to generate the interactive digital persona, wherein the data supplements, using retrieval-augmented generation (RAG), the trained AI model, and wherein the trained AI model generates the interactive digital persona.

14. The system of claim 12, wherein the processing device is further to:
identify at least one of index data or incidence data associated with the segment; and
provide the at least one of the index data or the incidence data to a trained AI model configured to generate the interactive digital persona, wherein the at least one of the index data or the incidence data supplements, using RAG, the trained AI model, and wherein the trained AI model generates the interactive digital persona.

15. The system of claim 12, wherein the processing device is further to:
identify additional data associated with at least a subset of the segment, wherein the additional data comprises at least one of context data or experience data, wherein the experience data reflects one or more actions taken by one or more members of the segment, and wherein the context data reflects contextual information of a corresponding action of the one or more actions; and
provide the additional data to a trained AI model, wherein the additional data supplements, using RAG, the trained AI model, and wherein the trained AI model generates the interactive digital persona.

16. The system of claim 12, wherein to cause the interactive digital persona representing the segment to be provided to the user device, the processing device is further to:
provide a graphical user interface (GUI) for display on a user interface (UI) of the user device, wherein the GUI comprises a first portion to receive an interaction of a user of the user device, wherein the GUI comprises a second portion to display a response generated by a trained AI model, wherein the trained AI model generates the interactive digital persona.

17. The system of claim 16, wherein the GUI comprises an avatar representing a member of the segment.

18. The system of claim 12, wherein the processing device is further to:
receive an interaction of a user of the user device, wherein the interaction is associated with the interactive digital persona, and wherein the interaction comprises at least one of a textual input or an audio input;
provide the interaction of the user as input to a trained AI model, wherein the trained AI model is trained to generate the interactive digital persona;
receive an output from the trained AI model, wherein the output comprises a response of the interactive digital persona to the interaction of the user; and
provide, for display on a user interface, the output, wherein the output comprises at least one of a textual output or an audio output.

19. The system of claim 12, wherein the processing device is further to:
identify one or more trained AI models, wherein each of the one or more trained AI models corresponds to a distinct segment of a plurality of segments of the population, wherein the plurality of segments comprises the segment of the population, wherein each of the one or more trained AI models is trained to generate a corresponding interactive digital persona;
receive an interaction of a user of the user device, wherein the interaction is associated with the interactive digital persona, and wherein the interaction comprises at least one of a textual input or an audio input;
provide the interaction as input to the one or more trained AI models;
receive one or more outputs from the one or more trained AI models, wherein each of the one or more outputs is received from a corresponding trained AI model of the one or more trained AI models, and wherein each of the one or more trained AI models corresponds to a distinct interactive digital persona; and
provide, for display on a user interface of the user device, the one or more outputs, wherein each of the one or more outputs comprise at least one of a textual output or an audio output.

20. A non-transitory computer-readable storage medium comprising instructions that, when executed by a processing device, cause the processing device to:
identify data associated with a segment of a population, wherein data comprises one or more characteristics of the segment;
generate, based on the data, an interactive digital persona representing the segment; and
cause the interactive digital persona representing the segment to be provided to a user device.
